(19) United States
(12) Patent Application Publication
(10) Pub. No.: US 2024/0259748 A1
(43) Pub. Date: Aug. 1, 2024

(54) APPARATUS AND METHOD FOR CONTROLLING SOUND FIELD

(71) Applicant: ALPS ALPINE CO., LTD., Tokyo (JP)

(72) Inventor: Tomohiko ISE, Iwaki (JP)

(73) Assignee: ALPS ALPINE CO., LTD., Tokyo (JP)

(21) Appl. No.: 18/417,628

(22) Filed: Jan. 19, 2024

(30) Foreign Application Priority Data
Jan. 26, 2023 (JP) 2023-084065
May 22, 2023 (JP) 2023-010456

(51) Int. Cl. H04S 7/00; H04R 3/12; H04R 5/04

(52) U.S. Cl. CPC H04S 7/30; H04R 3/12; H04R 5/04

(57) ABSTRACT

The present disclosure teaches a filtering unit configured to perform filtering on input audio signals in accordance with coefficients set for a plurality of audio outputs, respectively, and a plurality of speakers configured to output audio in response to audio signals filtered for the plurality of audio outputs. The filtering unit performs the filtering on the input audio signals in accordance with the coefficients adjusted so that the sound pressures and the sound pressure gradients at a plurality of control points set on a boundary plane of an enclosed space surrounding the plurality of speakers reach values corresponding to a desired sound field. This allows producing a desired sound field on the boundary plane of the enclosed space surrounding the sound sources by making use of the properties of the Kirchhoff-Helmholtz integral equation that requires that the sound sources are present in an enclosed space.

### RELATED APPLICATION

The present application claims priority to Japanese Patent Application Number 2023-084065, filed Jan. 26, 2023, and Japanese Patent Application Number 2023-010456, filed May 22, 2023, the entirety of each of which is hereby incorporated by reference.

### BACKGROUND

### 1. Field of the Disclosure

The present disclosure relates to an apparatus and a method for controlling a sound field, and in particular, to an apparatus and a method for producing a sound field by controlling a sound pressure and a sound pressure gradient at a predetermined control point.

### 2. Description of the Related Art

In recent years, there has been an increasing opportunity to engage in conversation using computers in both home and workplaces with the growing popularity of telecommuting, online meetings, and the emergence of the metaverse and esports. In such cases, using a headset for a long time causes harmful effects such as ear pain. For this reason, there is a need to engage in conversation using a computer's microphone and speaker without the use of a headset. In this case, however, the sound output from the speaker can leak and be heard by others in the vicinity.

To cope with this problem, there is a known technique for reproducing sound only in a specific space to prevent the sound from leaking to the outside (for example, see JP2004-349795 (PTL 1), JP2005-142632 (PTL 2), and WO2013-099093 (PTL 3). PTLs 1 to 3 disclose sound field control methods using properties of the Kirchhoff-Helmholtz integral equation. In another known example, there is a sound field control method for determining the characteristics of multiple filters so as to reproduce predetermined signal transfer characteristics for multiple control points (for example, see JP2005-249989 (PTL 4)).

Among them, in one example, paragraph in PTL 1 discloses a sound field control method using the properties of the Kirchhoff-Helmholtz integral equation in which sound is played back only in the enclosed space by selecting a space including a playback speaker (a primary sound source) as any enclosed space, and by adaptively controlling the output of a control speaker (a secondary sound source) so that the sound pressure and the sound pressure gradient on the boundary plane of the space become zero.

However, with the techniques disclosed in PTLs 1 to 4, the control points at which sound pressure/sound pressure gradient sensors and microphones are disposed are located only in front of the speakers, as illustrated in FIGS. 2 and 3 in PTL 1, FIGS. 1 and 2 in PTL 2, FIGS. 9, 23, 24, 27, and 30 in PTL 3, and FIG. 3 in PTL 4, in which local spaces are formed by arranging the multiple control points, but an enclosed space that surrounds the sound sources is not formed.

For this reason, it can be said that the techniques disclosed in PTLs 1 to 4 are not feasible to perform precise sound field control using the properties of the Kirchhoff-Helmholtz integral equation that requires that the sound sources are present in an enclosed space. Thus, even with the techniques disclosed in PTLs 1 to 4, it is difficult to produce a desired sound field on the boundary plane of an enclosed space surrounding the sound sources by making effective use of the properties of the Kirchhoff-Helmholtz integral equation.

Furthermore, to control the sound field using the method described in paragraph of PTL 1, a control speaker (a secondary sound source) is required in addition to the playback speaker (a primary sound source). This configuration not only requires many speakers but also faces the limitation that the method can only be applied to environments in which the control speaker can be placed on the boundary plane of the enclosed space.

### SUMMARY

The present disclosure has been made to address the above problems, and accordingly, it is an object of the present disclosure to produce a desired sound field, using sound sources installed in an enclosed space, on the boundary plane of the enclosed space surrounding the sound sources by making use of the properties of the Kirchhoff-Helmholtz integral equation.

To address the above problems, the present disclosure includes a filtering unit configured to perform filtering on input audio signals in accordance with coefficients set for a plurality of audio outputs, respectively, and a plurality of speakers configured to output audio in response to audio signals filtered for the plurality of audio outputs by the filtering unit, wherein the filtering unit is configured to perform the filtering on the input audio signals in accordance with the coefficients adjusted so that the sound pressures and the sound pressure gradients at a plurality of control points set on a boundary plane of an enclosed space surrounding the plurality of speakers reach values corresponding to a desired sound field.

The present disclosure with the above configuration allows producing a desired sound field, using sound sources installed in an enclosed space, on the boundary plane of the enclosed space surrounding the sound sources by making use of the properties of the Kirchhoff-Helmholtz integral equation that requires that the sound sources are present in the enclosed space.

### BRIEF DESCRIPTION OF THE DRAWINGS

FIG. 1 is a diagram illustrating a basic principle of a sound field control apparatus according to an embodiment;

FIG. 2 is a diagram illustrating an application principle of a sound field control apparatus according to an embodiment;

FIG. 3 is a diagram illustrating an example configuration of a sound field control apparatus according to a first embodiment;

FIG. 4 is a schematic diagram illustrating a configuration of an audio transfer system.

FIG. 5 is a schematic diagram illustrating a first design example;

FIG. 6 is a diagram illustrating a sound pressure distribution at a specific frequency in a first design example;

FIG. 7 is a diagram illustrating an attenuation of a sound pressure in the first design example;

FIG. 8 is a schematic diagram illustrating a second design example;

FIG. 9 is a diagram illustrating a sound pressure distribution at a specific frequency in the second design example;

FIG. 10 is a diagram illustrating the attenuation of the sound pressure in the second design example;

FIG. 11 is a schematic diagram illustrating a third design example;

FIG. 12 is a diagram illustrating a sound pressure distribution at a specific frequency in the third design example;

FIG. 13A is a diagram illustrating an attenuation of a sound pressure in the third design example;

FIG. 13B is a diagram illustrating an attenuation of a sound pressure in the second design example;

FIG. 14-(a), (b), (c) is a schematic diagram illustrating fourth to sixth design examples;

FIG. 15A is a diagram illustrating a sound pressure distribution at a specific frequency simulated in a fourth design example;

FIG. 15B is a diagram illustrating a sound pressure distribution at a specific frequency simulated in a fifth design example;

FIG. 15C is a diagram illustrating a sound pressure distribution at a specific frequency simulated in a sixth design example;

FIG. 16A is a diagram illustrating an attenuation of a sound pressure in the fourth design example;

FIG. 16B is a diagram illustrating an attenuation of a sound pressure in the fifth design example;

FIG. 16C is a diagram illustrating an attenuation of a sound pressure in the sixth design example;

FIG. 17-(a), (b), (c) is a schematic diagram illustrating seventh to ninth design examples;

FIG. 18A is a diagram illustrating a sound pressure distribution at a specific frequency simulated in a seventh design example;

FIG. 18B is a diagram illustrating a sound pressure distribution at a specific frequency simulated in an eighth design example;

FIG. 18C is a diagram illustrating a sound pressure distribution at a specific frequency simulated in the ninth design example;

FIG. 19A is a diagram illustrating an attenuation of a sound pressure in the seventh design example;

FIG. 19B is a diagram illustrating an attenuation of a sound pressure in the eighth design example;

FIG. 19C is a diagram illustrating an attenuation of a sound pressure in the ninth design example;

FIG. 20 is a diagram illustrating an example configuration of a sound field control apparatus according to a second embodiment;

FIGS. 21A and 21B are schematic diagrams illustrating tenth design examples;

FIGS. 22A and 22B are diagrams illustrating sound pressures at individual control points in the tenth design examples:

FIG. 23 is a diagram illustrating an example configuration in which speakers are disposed at multiple location including a non-movable portion of an electronic device;

FIGS. 24A and 24B are diagrams illustrating a sound field control apparatus according to the third embodiment in which speakers are disposed at a movable portion;

FIGS. 25A and 25B are diagrams illustrating reflective objects in a fourth embodiment;

FIG. 26 is a diagram illustrating an example configuration of a sound field control apparatus according to a fourth embodiment;

FIGS. 27A to 27C are schematic diagrams illustrating examples of impulse response calculated by a function calculating unit according to the fourth embodiment;

FIG. 28 is a diagram illustrating another example configuration of a sound field control apparatus according to the fourth embodiment;

FIG. 29 is a diagram illustrating an example configuration of a sound field control apparatus according to a fifth embodiment;

FIG. 30 is a diagram illustrating an example configuration of a sound field control apparatus according to a first modification of the fifth embodiment;

FIG. 31 is a diagram illustrating an example configuration of a sound field control apparatus according to a second modification of the fifth embodiment;

FIG. 32 is a diagram illustrating an example configuration of a sound field control apparatus according to a third modification of the fifth embodiment; and

FIGS. 33A and 33B are diagrams illustrating modifications of an enclosed space.

### DETAILED DESCRIPTION

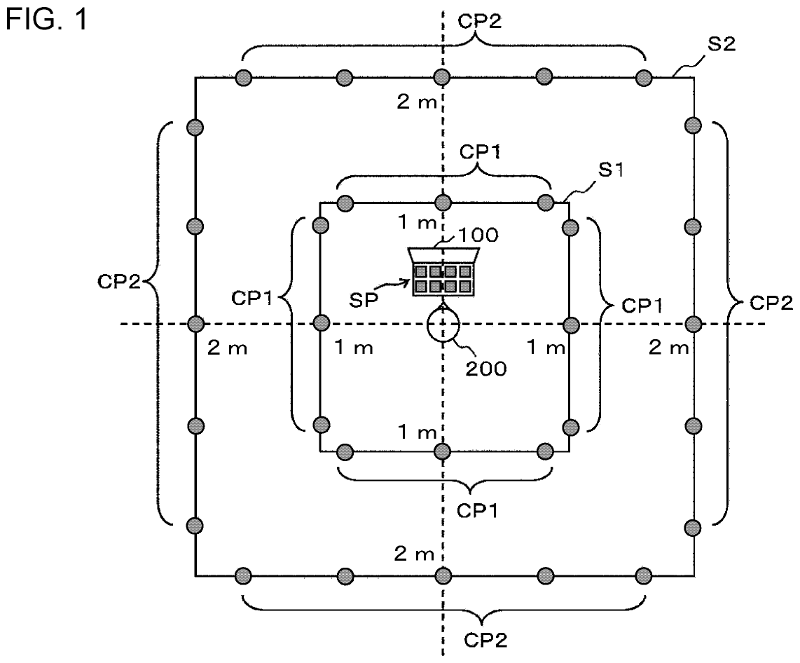

An embodiment of the present disclosure will be described with reference to the drawings. First, a basic principle of a sound field control apparatus according to this embodiment will be described with reference to FIG. 1. As illustrated in FIG. 1, an electronic device (for example, a notebook computer) 100 that a user 200 uses includes a plurality of (eight in the example in FIG. 1) speakers SP. Around the multiple speakers SP, a first enclosed space (an inner enclosed space) S1 surrounding the multiple speakers SP and a second enclosed space (an outer enclosed space) S2 surrounding the first enclosed space S1 are assumed.

In this case, a sound pressure p(x) at any position x in the region between the first enclosed space S1 and the second enclosed space S2 is defined by the Kirchhoff-Helmholtz integral equation expressed by Eq. 1. In other words, the sound pressure p(x) at any position x is calculated by integrating the difference between the product of a Green's function G(r|x, ω) and a sound pressure gradient ∂p(r, ω)/∂n and the product of a sound pressure p(r, ω) and a gradience ∂G(r|x, ω)/On of the Green's function over the region between the first enclosed space S1 and the second enclosed space S2. The sound pressure p(x) at any position x is a value that depends on a coefficient ω indicating the relationship between a sound pressure p(r) at a position r on the boundary plane of the first enclosed space S1 and a sound pressure p(r) at a position r on the boundary plane of the second enclosed space S2.

$$p ( x , ω ) = \int {\int }_{S 1 + S 2} [ G ( r \vert x , ω ) \frac{\partial p ( r , ω )}{\partial n} - p ( r , ω ) \frac{\partial G ( r \vert x , ω )}{\partial n} ] δ S \qquad ( Eq . 1 )$$

In this embodiment, a desired sound field is produced in the region between the first enclosed space S1 and the second enclosed space S2 by adjusting the coefficient ω so that a sound pressure p(r) and a sound pressure gradient ∂p(r, ω)/∂n at multiple control points CP1, CP1, . . . (hereinafter simply referred to as control points CP1) set on the boundary plane of the first enclosed space S1 reach values corresponding to the desired sound field, and that a sound pressure p(r) and a sound pressure gradient ∂p(r, ω)/∂n at multiple control points CP2, CP2, . . . (hereinafter simply referred to as control points CP2) set on the boundary plane of the second enclosed space S2 reach values corresponding to the desired sound field.

In particular, the sound pressure p(x) in the region between the first enclosed space S1 and the second enclosed space S2 is controlled to zero by adjusting the coefficient ω so that the sound pressure p(r) and the sound pressure gradient ∂p(r, ω)/∂n at the multiple control points CP1 set on the boundary plane of the first enclosed space S1 become zero, and that the sound pressure p(r) and the sound pressure gradient ∂p(r, ω)/∂n at the multiple control points CP2 set on the boundary plane of the second enclosed space S2 become zero.

When both the sound pressure p(r) and the sound pressure gradient p(r, ω)/∂n on the boundary plane of the second enclosed space S2 become zero, the sound pressure and the sound pressure gradient in the space outside the second enclosed space S2 inevitably become zero. Since the sound pressure p(x) in the region between the first enclosed space S1 and the second enclosed space S2 is controlled to zero, the sound pressure of the space outside the first enclosed space S1 becomes zero. This allows producing a sound field in which the sound output from the speakers SP is separated by the boundary plane of the first enclosed space S1 so that the sound is not released to the outside of the first enclosed space S1. It is difficult to completely decay the sound pressure outside the first enclosed space S1 to zero but is possible to decrease the sound pressure.

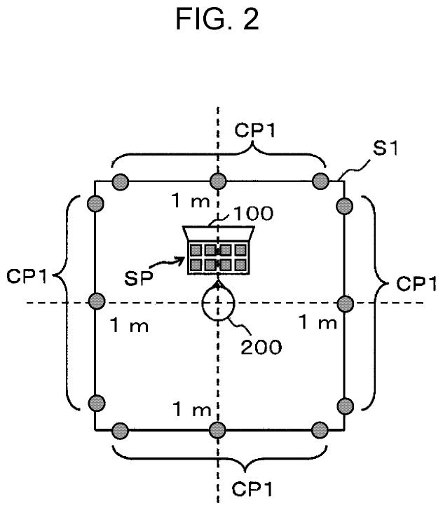

In theory, if the sound pressure p(r) and the sound pressure gradient ∂p(r, ω)/∂n on the boundary plane of the first enclosed space S1 become zero, the sound pressure p(r) and the sound pressure gradient ∂p(r, ω)/∂n of the second enclosed space S2 outside of it also falls to zero. Accordingly, adjusting the coefficient ω so that both the sound pressure p(r) and the sound pressure gradient ∂p(r, ω)/∂n on the boundary plane of the first enclosed space S1 become zero on the assumption that only the first enclosed space S1 surrounding the multiple speakers SP as in FIG. 2 allows producing zone sound, that is, preventing the sound output from the speakers SP from being released outside the first enclosed space S1.

### First Embodiment

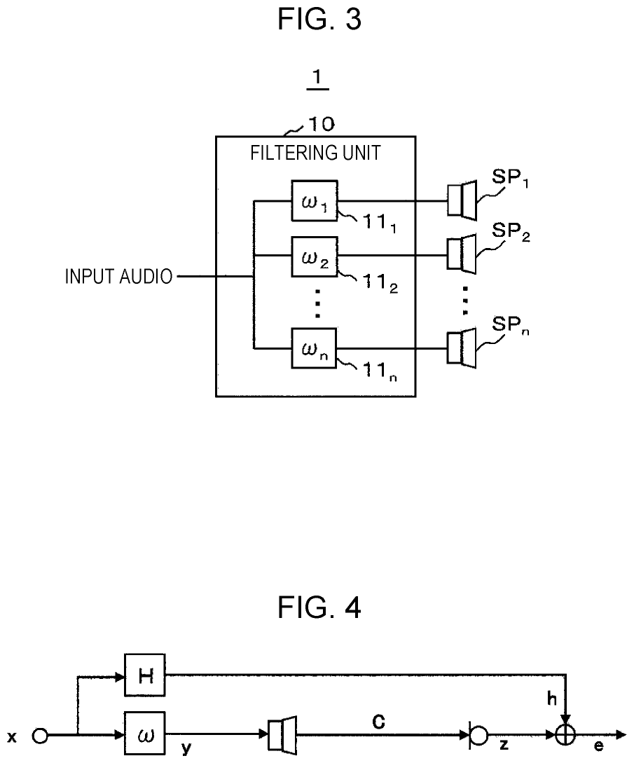

FIG. 3 is a diagram illustrating an example configuration of a sound field control apparatus 1 according to a first embodiment. As illustrated in FIG. 1, the sound field control apparatus 1 according to the first embodiment includes a filtering unit 10 and multiple speakers SP1, SP2, . . . , SPn (hereinafter, if no special distinction is made, simply referred to as speakers SP). The filtering unit 10 includes multiple FIR filters 111, 112, . . . , 11n (hereinafter, if no special distinction is made, simply referred to as finite impulse response (FIR) filters 11). The sound field control apparatus 1 is installed in a personal computer, such as a notebook computer 100 or a desktop personal computer.

The filtering unit 10 performs filtering on the input audio signals using the FIR filters 111, 112, . . . , 11n in accordance with coefficients ω1, ω2, . . . , on (hereinafter, if no special distinction is made, simply referred to as coefficients ω) set for individual multiple audio outputs. One example of the input audio signals is an audio signal generated by a personal computer. For example, in the case of an online conference using a personal computer, the audio signals are audio signals transmitted from a terminal on the other side via a communication network. The speakers SP output audio based on audio signals filtered for multiple audio outputs by the filtering unit 10.

The filtering unit 10 performs filtering on the input audio signals in accordance with the coefficients ω adjusted so that the sound pressures and sound pressure gradients at multiple control points set on the boundary plane of an enclosed space surrounding the multiple speakers SP reach values corresponding to a desired sound field. In this embodiment, the filtering unit 10 performs filtering on the input audio signals according to, for example, the basic principle illustrated in FIG. 1, in accordance with the coefficients ω adjusted so that the sound pressures and the sound pressure gradients at the multiple control points CP1 set on the boundary plane of the first enclosed space S1 become zero, and the sound pressures and the sound pressure gradients at the multiple control points CP2 set on the boundary plane of the second enclosed space S2 become zero. Alternatively, the filtering unit 10 may perform filtering on the input audio signals, according to the application principle illustrated in FIG. 2, in accordance with the coefficients ω adjusted so that the sound pressures and the sound pressure gradients on the multiple control points CP1 seton the boundary plane of the first enclosed space S1 become zero.

The respective coefficients ω1, ω2, . . . , on set for the multiple FIR filters 111, 112, . . . , 11n are adjusted in advance using sound pressures and sound pressure gradients detected by multiple sound pressure/sound pressure gradient sensors (not illustrated) set at the multiple control points CP1 and CP2. Adjusted coefficients ω are set as fixed values. The multiple sound pressure/sound pressure gradient sensors are used only in adjusting the coefficients ω and become unnecessary after the adjusted coefficients w are set for the FIR filters 11.

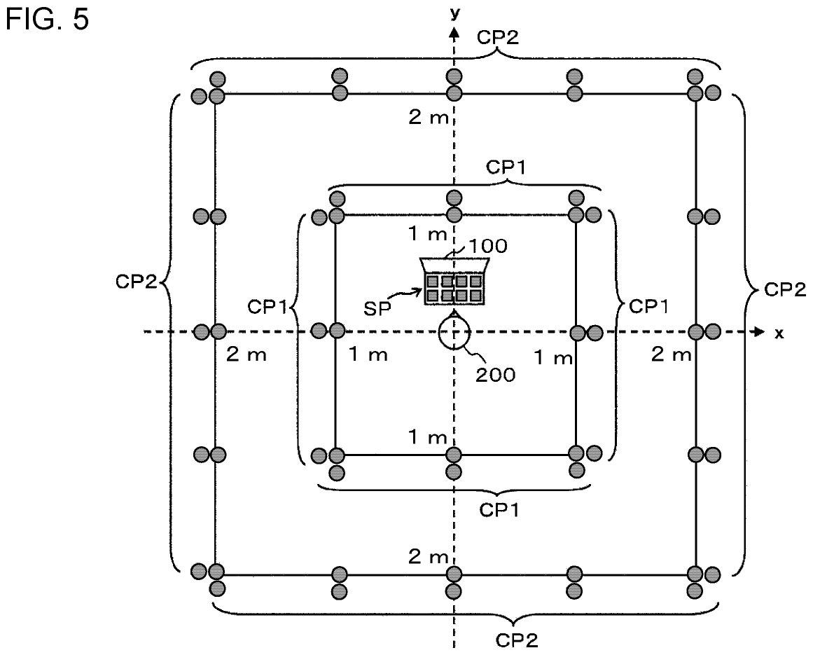

One example of a method for adjusting the coefficients ω will be described hereinbelow with reference to FIG. 4. FIG. 4 is a schematic diagram illustrating the configuration of an audio transfer system. In FIG. 4, x denotes an input audio signal, ω denotes coefficients ω1, ω2, . . . , on set for the multiple FIR filters 111, 112, . . . , 11n, respectively, y denotes a filtered audio signal, C denotes an acoustic transfer function until the audio output from the multiple speakers SP1, SP2, . . . , SPn is input to multiple sound pressure/sound pressure gradient sensors, z denotes the sound pressures and the sound pressure gradients detected by the sound pressure/sound pressure gradient sensors, H denotes a target transfer function indicating characteristics for producing a desired sound field, h denotes a target response, which is zero when both the sound pressures and the sound pressure gradients at the multiple control points CP1 and CP2 set on the boundary planes are zero, and e denotes the error between each sensor output z and the target response h.

For example, when an inverse matrix is used, the coefficients ω can be calculated as follows.

$$y = ω x$$

$$z = Cy = C ω x$$

$$h = Hx$$

If z is set equal to h to adjust the coefficients ω so that the output z of each sound pressure/sound pressure gradient sensor is equal to the target response h,

$$C ω x = Hx$$

$$∴ ω = C - 1 H .$$

If the number of the speakers SP and the number of the sound pressure/sound pressure gradient sensors are not equal, the coefficients ω can be calculated using the following equation using a Moore-Penrose pseudo-inverse matrix C+, instead of the inverse matrix of the transfer function, C-1.

$$ω = C + H$$

When a Wiener filter is used, the coefficient ω can be calculate as follows.

$$y = ω x$$

$$z = Cy = C ω x$$

$$h = Hx$$

$$e = h - z = ( H - C ω ) x$$

$$e 2 = H 2 \times 2 - 2 HC ω x \times 2 + C 2 ω2 \times 2$$

where, the minimum value of the error power e2 is expressed as follows because the gradience is zero.

$$\partial e 2 / \partial ω = - 2 HC \times 2 + 2 C 2 ω \times 2 = 0$$

$$∴ ω = HC \times 2 / C 2 \times 2$$

Next, specific design examples will be described.

### First Design Example

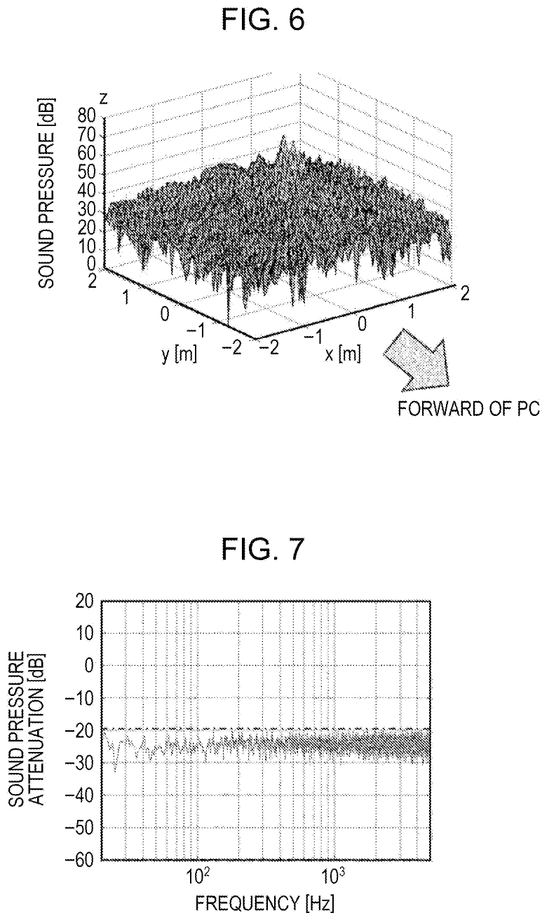

FIG. 5 is a schematic diagram illustrating a first design example. In the first design example, as illustrated in FIG. 5, the number of speakers SP installed in the notebook computer 100 is eight, and the first enclosed space S1 and the second enclosed space S2 are assumed around the eight speakers SP. The first enclosed space S1 is a rectangular space of 2 m square centered on the position of the user 200. The second enclosed space S2 is a rectangular space of 4 m square centered on the position of the user 200.

Twenty control points CP1 are set on the boundary plane of the first enclosed space S1, 36 control points CP2 are set on the boundary plane of the second enclosed space S2, and sound pressure/sound pressure gradient sensors are placed at the 56 control points CP1 and CP2. As illustrated in FIG. 5, three sound pressure/sound pressure gradient sensors are place at each of the four corners of the enclosed spaces S1 and S2, and two sound pressure/sound pressure gradient sensors are placed per location on the boundary planes other than the four corners (on each plane of the rectangular regions).

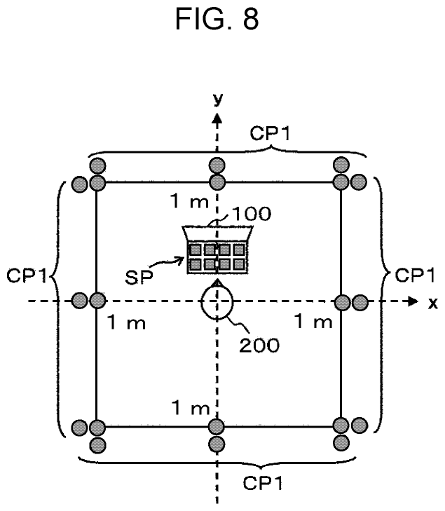

FIG. 6 is a diagram illustrating a sound pressure distribution at a specific frequency simulated inside the second enclosed space S2. In FIG. 6, the region of the enclosed space is indicated by the x-axis and the y-axis, and sound pressures at individual positions in the region are indicated by the z-axis. As illustrated in FIG. 6, the sound pressure is lower outside the first enclosed space S1 than inside the first enclosed space S1 (the region in the vicinity of the center of FIG. 6).

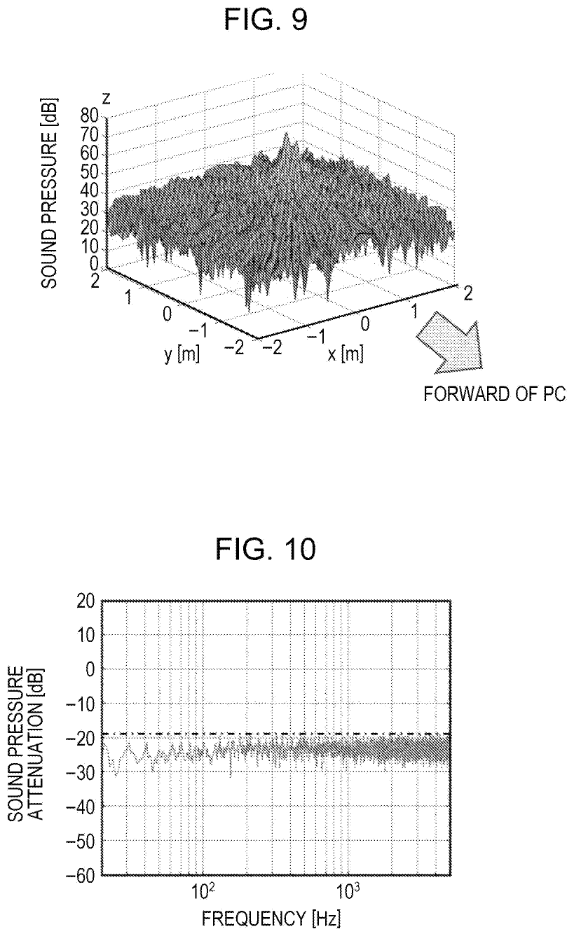

FIG. 7 is a diagram illustrating the attenuation of the sound pressure outside the first enclosed space S1 from the sound pressure inside the first enclosed space S1 (hereinafter referred to as “attenuation of sound pressures between inside and outside of the first enclosed space S1”). In FIG. 7, the horizontal axis indicates frequency, and the vertical axis indicates the average attenuation of the sound pressures outside the first enclosed space S1 relative to the inside sound pressures. As illustrated in FIG. 7, in all frequency bands, the sound pressures outside the first enclosed space S1 attenuates by an average of about 20 dB compared to the sound pressures inside the first enclosed space S1.

### Second Design Example

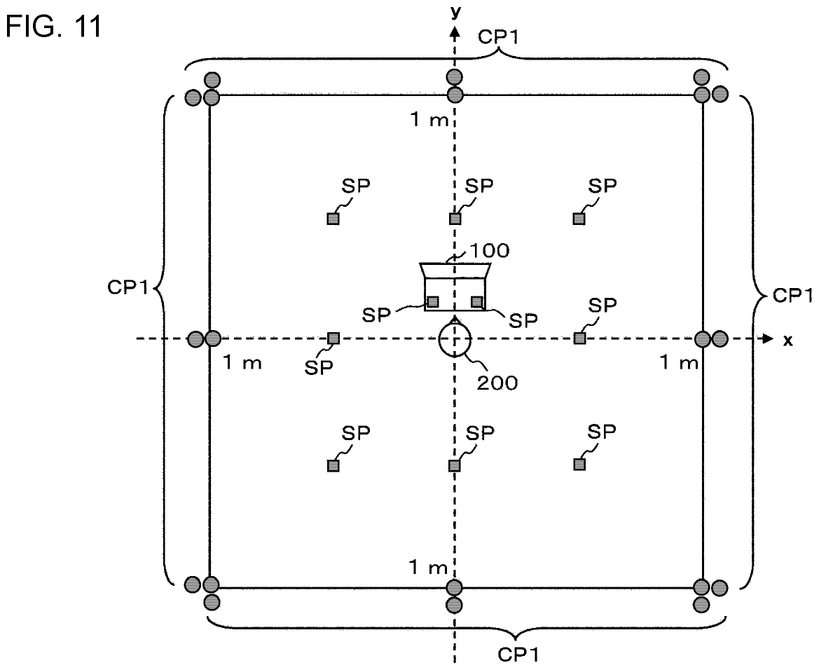

FIG. 8 is a schematic diagram illustrating a second design example. As shown in FIG. 8, in the second design example, only the first enclosed space S1 is assumed around eight speakers SP, and 20 control points CP1 are set on the boundary plane. The others are the same as in the first design example.

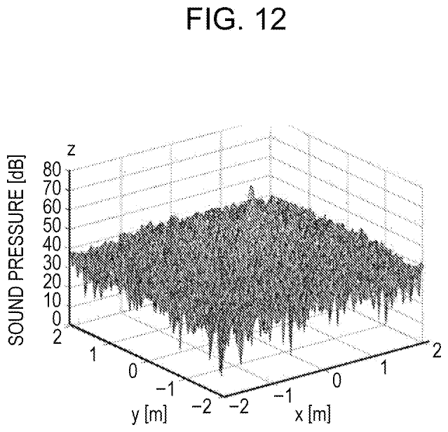

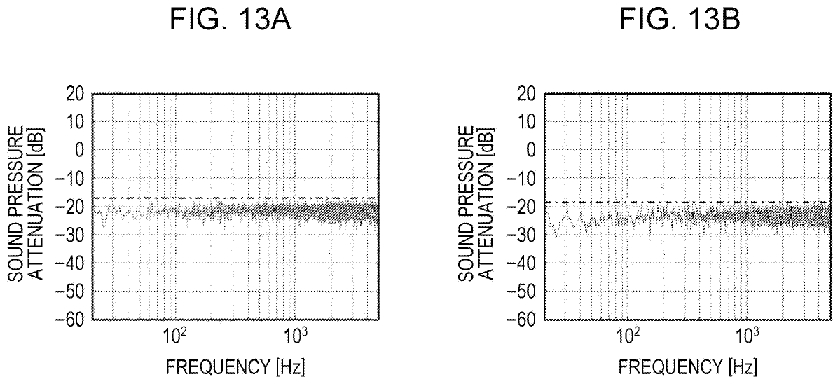

FIG. 9 is a diagram illustrating a sound pressure distribution at a specific frequency inside the second enclosed space S2. As illustrated in FIG. 9, in the second design example as well, the sound pressures outside the first enclosed space S1 are lower than those inside the first enclosed space S1. FIG. 10 illustrates the sound pressure attenuation between inside and outside the first enclosed space S1. As is evident from FIG. 10, the sound pressures outside the first enclosed space S1 attenuate by an average of about 20 dB from the sound pressures inside the first enclosed space S1. The performance deterioration is reduced to about 1 dB compared with the first design example.

### Third Design Example

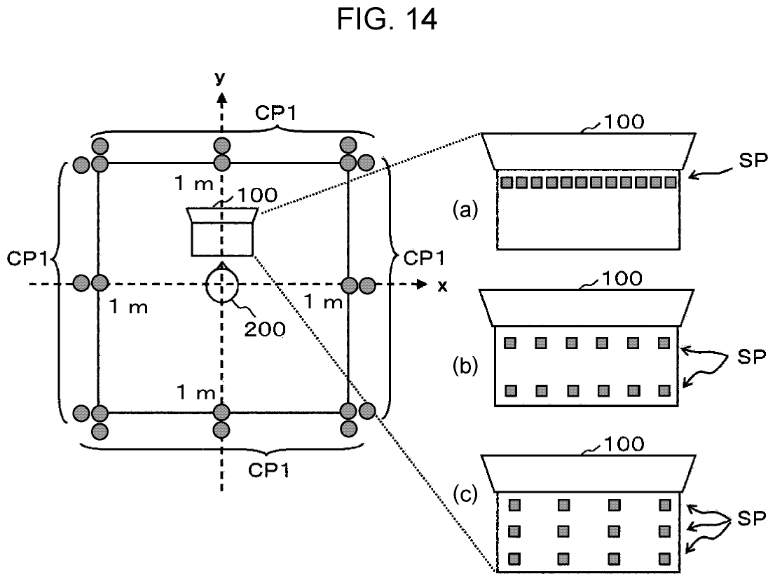

FIG. 11 is a schematic diagram illustrating a third design example. As illustrated in FIG. 11, in the third design example, two speakers SP are installed in the notebook computer 100, and eight speakers SP are placed around the notebook computer 100. The others are the same as in the second design example.

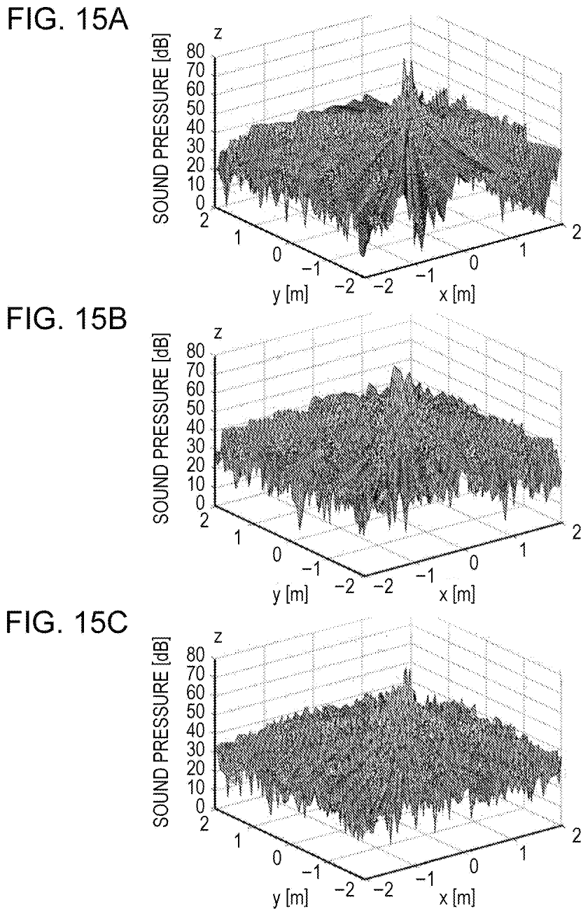

FIG. 12 is a diagram illustrating a sound pressure distribution at a specific frequency inside the second enclosed space S2. As is evident from FIG. 12, in the third design example as well, the sound pressures outside the first enclosed space S1 are lower than those inside the first enclosed space S1.

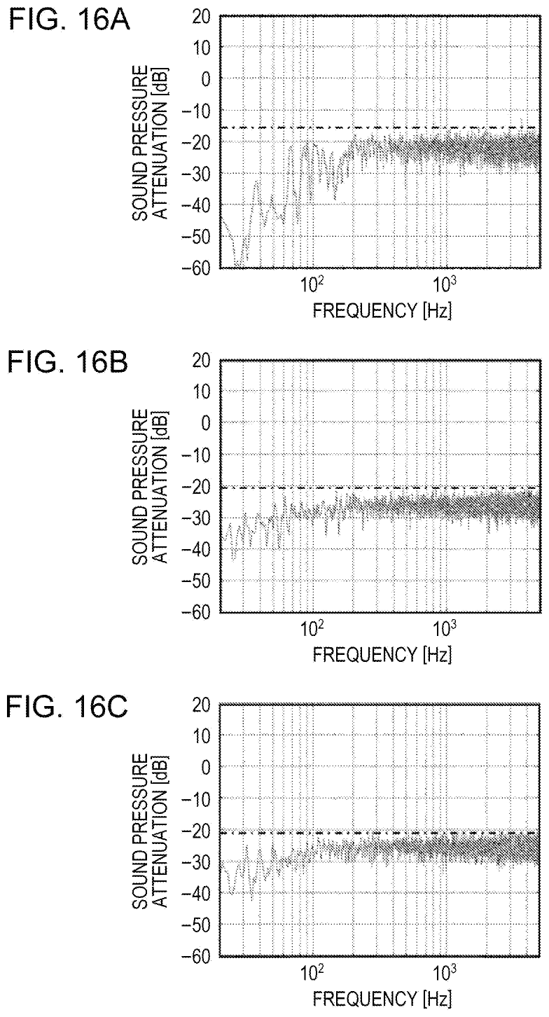

FIGS. 13A and 13B are diagrams illustrating the sound pressure attenuation between inside and outside the first enclosed space S1 compared with the second design example. FIG. 13A illustrates the third design example, and FIG. 13B illustrates the second design example. As is evident from FIG. 13A, the sound pressures outside the first enclosed space S1 attenuate by an average of about 20 dB from the sound pressures inside the first enclosed space S1. However, the attenuation is higher in the second design example illustrated in FIG. 13B. This suggests that arraying the speakers SP on the notebook computer 100 as in FIG. 8 has a better sound pressure attenuation effect than disposing the speakers SP around the notebook computer 100 as in FIG. 11. The array arrangement is beneficial in concentrating the multiple speakers SP on the notebook computer 100.

### Fourth to Sixth Design Examples

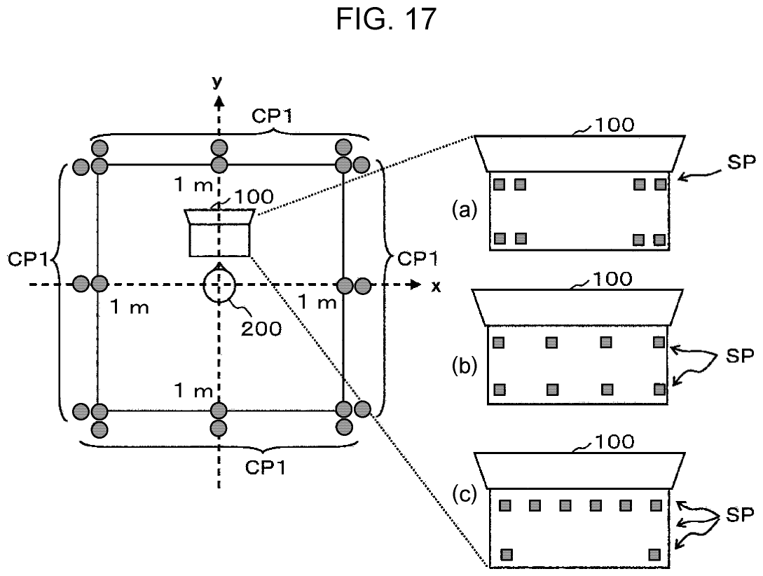

FIG. 14-(a), (b), (c) is a schematic diagram illustrating fourth to sixth design examples, respectively. As illustrated in FIG. FIG. 14-(a), (b), (c), in the fourth to sixth design examples, multiple speakers SP are arrayed on the notebook computer 100, but the number of rows differs. In the fourth design example illustrated in FIG. 14-(a), 12 speakers SP are arrayed in one row. In the fifth design example illustrated in FIG. 14-(b), 12 speakers SP are arranged in two rows (six speakers per row). In the sixth design example illustrated in FIG. 14-(c), 12 speakers SP are arranged in three rows (four speakers per row). The others are the same as in the second design example.

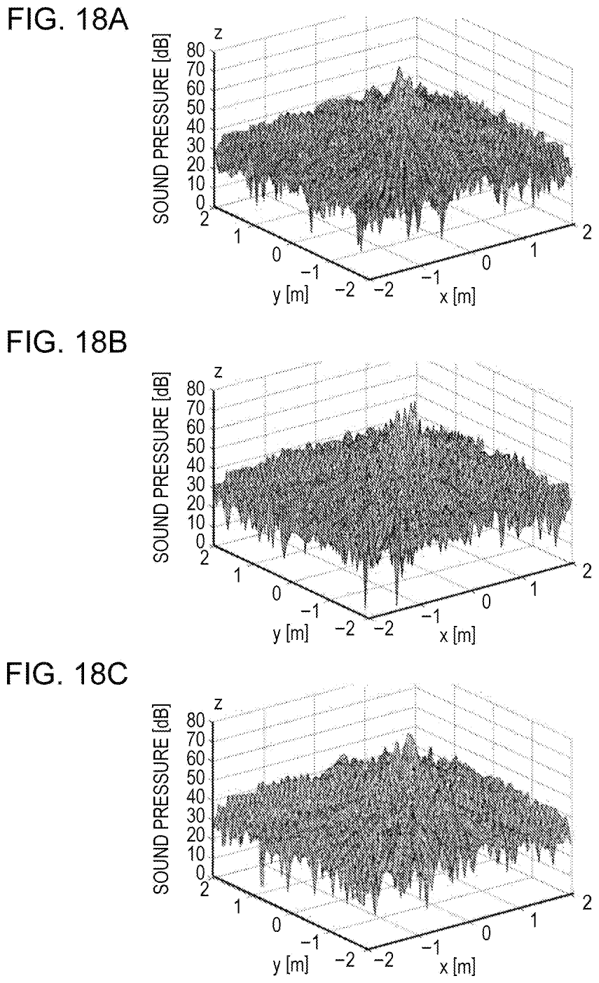

FIGS. 15A to 15C are diagrams illustrating a sound pressure distribution at a specific frequency simulated inside the second enclosed space S2 in the fourth to sixth design examples, respectively. As is evident from FIGS. 15A to 15C, in any of the fourth to sixth design examples, the sound pressures are lower outside the first enclosed space S1 than inside the first enclosed space S1.

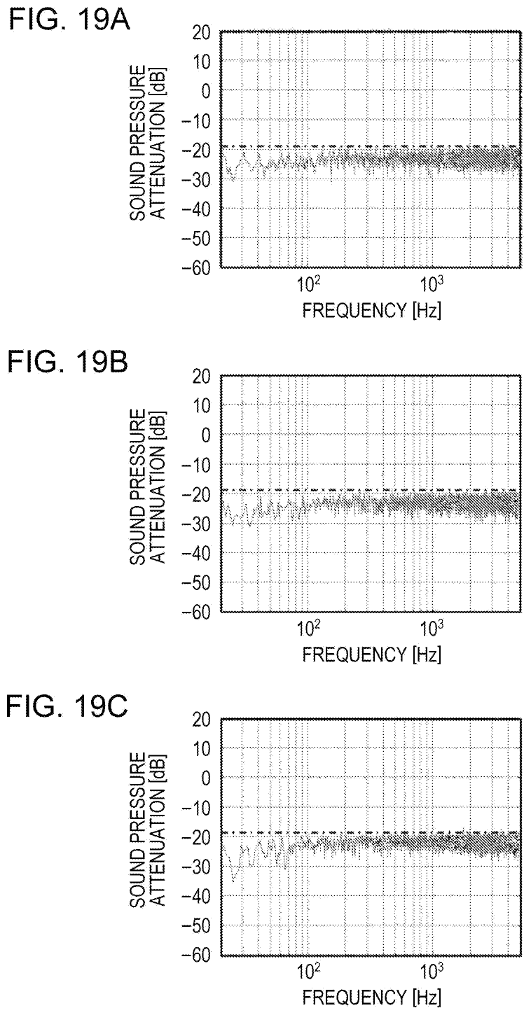

FIGS. 16A to 16C are diagrams illustrating the sound pressure attenuation between inside and outside the first enclosed space S1 measured in the fourth to sixth design example, respectively. As is evident from FIG. 16A, in the fourth design example, the attenuation is lower than 20 dB in the mid- and high-frequency bands, where the sound separation effect is low. In contrast, in the fifth to sixth design examples, an attenuation of 20 dB or more is achieved in all the frequency bands. This suggests that arranging multiple speakers SP in two or more rows enhances the sound pressure attenuation effect.

Since there is no significant difference in attenuation between two and three rows, increasing the rows to three or more may not enhance the sound pressure attenuation effect. For this reason, the speakers SP may be arrayed in two rows in decreasing the number of speakers SP.

### Seventh to Ninth Design Example

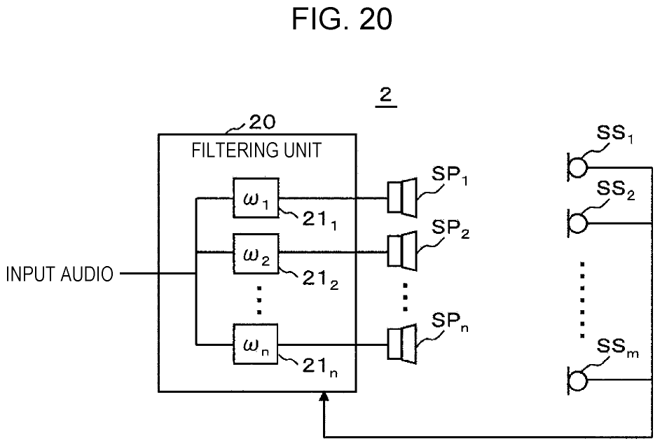

FIGS. 17(a) to 17(c) are schematic diagrams illustrating seventh to ninth design examples, respectively. As illustrated in FIGS. 17(a) to 17(c), in the seventh to ninth design examples, the multiple speakers SP are arrayed in two rows on the notebook computer 100 in different arrangements. In the seventh and eighth design examples, eight speaker SP are arranged, four in each row. In the seventh design example illustrated in FIG. 17(a), the four speakers SP in each row are arranged at irregular intervals. In the eighth design example illustrated in FIG. 17(b), the four speakers SP in each row are arranged at regular intervals. In the ninth design example illustrated in FIG. 17(c), two speakers SP are arranged in the first row, and six speakers SP are arranged in the second row. The others are the same as in the second design example.

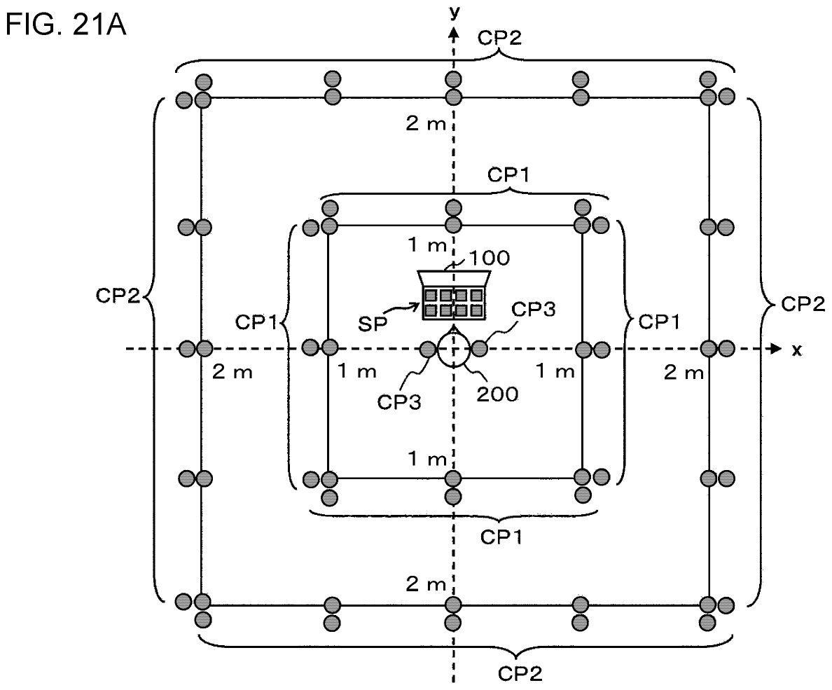

FIGS. 18A to 18C are diagrams illustrating a sound pressure distribution at a specific frequency simulated inside the second enclosed space S2 in the seventh to ninth design examples, respectively. As is evident from FIGS. 18A to 18C, the sound pressures are lower outside the first enclosed space S1 than those inside the first enclosed space S1 in any of the seventh to ninth design examples.

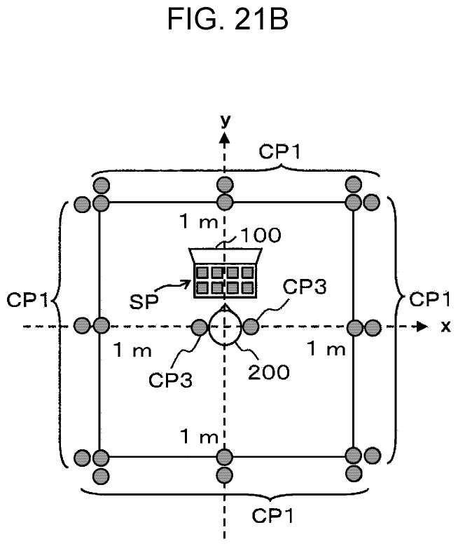

FIGS. 19A to 19C illustrate the sound pressure attenuation between inside and outside the first enclosed space S1 measured for the seventh to ninth design examples, respectively. As is evident from FIGS. 19A to 19C, in any of the seventh to ninth design examples, the sound pressures outside the first enclosed space S1 attenuate by an average of about 20 dB in all the frequency bands from the sound pressures inside the first enclosed space S1. This suggests that arranging the multiple speakers SP in two rows causes no significant difference in sound pressure attenuation effect depending on the placement. This allows the multiple speakers SP to be arranged according to, for example, the design of the notebook computer 100.

### Second Embodiment

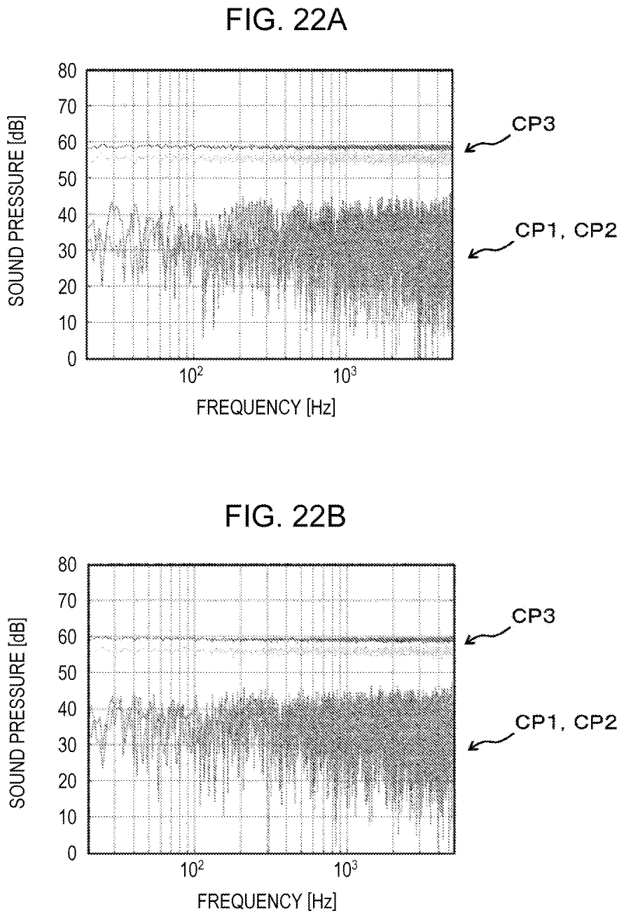

FIG. 20 is a diagram illustrating an example configuration of a sound field control apparatus 2 according to a second embodiment. In FIG. 20, the components having the same functions as the components illustrated in FIG. 3 are given the same reference signs.

As illustrated in FIG. 20, the sound field control apparatus 2 according to the second embodiment includes a filtering unit 20 in place of the filtering unit 10. The sound field control apparatus 2 according to the second embodiment further includes multiple sound pressure/sound pressure gradient sensors SS1, SS2, . . . , SPm (hereinafter, if no special distinction is made, simply referred to as sound pressure/sound pressure gradient sensors SS) disposed at the multiple control points CP1 and CP2. In the second embodiment, the filtering unit 20 includes adaptive filters in which the coefficients ω are variously set using sound pressures and sound pressure gradients detected by the multiple sound pressure/sound pressure gradient sensors SS.

The filtering unit 20 performs filtering on the input audio signals using multiple adaptive filters 211, 212, . . . , 21n in accordance with the coefficient ω1, ω2, . . . , on set for multiple audio outputs. The coefficient ω1, ω2, . . . , on set for the multiple adaptive filters 211, 212, . . . , 21n, respectively, are adjusted in real time using the sound pressures and the sound pressure gradients detected by the multiple sound pressure/sound pressure gradient sensors SS1, SS2, . . . , SPm disposed at the multiple control points CP1 and CP2. The speakers SP output audio in response to the audio signals filtered for multiple audio outputs by the filtering unit 20.

One example of a method for adjusting the coefficients ω using the adaptive filters 21 will be described with reference to FIG. 4. If the adaptive filters 21 are used, the coefficient ω can be calculated as follows.

$$y = ω x$$

$$z = Cy = C ω x$$

$$h = Hx$$

$$e = h - z = ( H - C ω ) x$$

$$e 2 = H 2 \times 2 - 2 HC ω \times 2 + C 2 ω2 \times 2$$

$$\partial e 2 / \partial ω = - 2 HC \times 2 + 2 C 2 ω \times 2 = - 2 eCx$$

The filter coefficient ω is converged to an optimum value by sequentially updating the coefficient ω using the gradience ∂e2/∂ω of the error power using the following equation.

$$ω ( n + 1 ) = ω ( n ) + 2 μ eCx$$

where the step size parameter μ is any constant for adjusting the amount of update.

The second embodiment that includes the multiple sound pressure/sound pressure gradient sensors SS and uses the adaptive filters 21 as the filtering unit 20 is more suitable for a system in which multiple speakers SP are installed in a desktop computer placed at a fixed position than for a design in which multiple speakers SP are installed in a mobile terminal, such as the notebook computer 100. The second embodiment can also be applied to in-vehicle audio systems in which the positions of the speakers SP and the positions of the sound pressure/sound pressure gradient sensors SS are fixed. The second embodiment can also be applied to a system in which speakers SP are arranged in a surrounding manner, as in the third design example illustrated in FIG. 11.

### Tenth Design Example

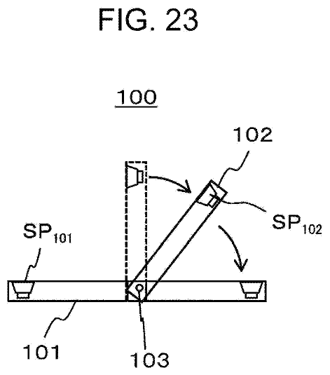

The first and second embodiments are examples in which the multiple control points CP1 and CP2 are set on the boundary planes of the enclosed spaces S1 and S2. Additional one or more control points may be set in an enclosed space (the region in the first enclosed space S1 or the region between the first enclosed space S1 and the second enclosed space S2). For example, additional two control points CP3 may be set in the vicinity of the notebook computer 100, where the user 200 is positioned, (for example, at the positions of the ears of the user 200), as in the tenth design example illustrated in FIGS. 21A and 21B. FIG. 21A illustrates a configuration in which two control points CP3 are added to the first design example illustrated in FIG. 5. FIG. 21B illustrates a configuration in which two control points CP3 are added to the second design example illustrated in FIG. 8.

In this case, the filtering unit 10 or 20 performs filtering on the input audio signals in accordance with the coefficients ω adjusted so that the sound pressures and the sound pressure gradients at the multiple control points CP1 and CP2 set on the boundary planes of the enclosed spaces S1 and S2 reach values corresponding to a desired sound field and that the sound pressures at the one or more control points CP3 set inside the enclosed spaces S1 and S2 reach a desired sound pressure.

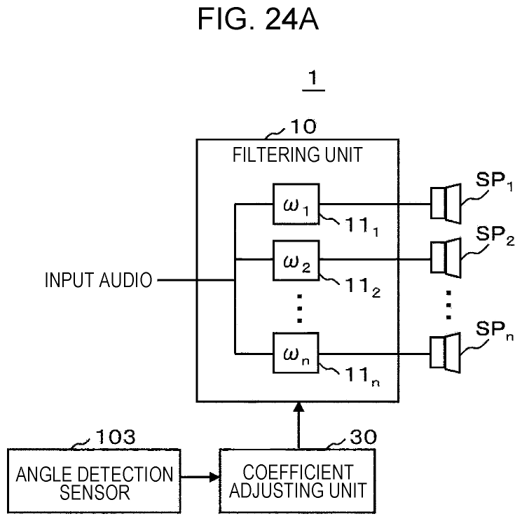

FIGS. 22A and 22B are diagrams illustrating sound pressures measured at the control points CP1, CP2, and CP3 in the design examples in which two control points CP3 are added, as in FIGS. 21A and 21B. FIG. 22A illustrates sound pressures in the design example of FIG. 21A. FIG. 22B illustrates sound pressures in the design example of FIG. 21B. As is evident from FIGS. 22A and 22B, the sound pressures measured at the control points CP3 at the ears of the user 200 are about 60 dB, while the sound pressures measured at the control points CP1 and CP2 on the boundary planes are 45 dB or lower. This indicates that audio separation can be achieved on the boundary plane of the first enclosed space S1 while still allowing the user to hear the audio from the speakers SP well with the ears.

As has been described in detail, this embodiment includes the filtering unit 10 or 20 configured to perform filtering on input audio signals in accordance with coefficients ω set for a plurality of audio outputs, respectively, and the plurality of speakers SP configured to output audio in response to audio signals filtered for the plurality of audio outputs by the filtering unit 10 or 20, wherein the filtering unit 10 or 20 performs the filtering on the input audio signals in accordance with the coefficients ω adjusted so that the sound pressures and the sound pressure gradients at a plurality of control points CP set on a boundary plane of an enclosed space surrounding the plurality of speakers SP reach values corresponding to a desired sound field.

This embodiment with the above configuration can produce a desired sound field on the boundary plane of an enclosed space surrounding multiple speakers SP installed in the enclosed space using the speakers SP by making use of the properties of the Kirchhoff-Helmholtz integral equation that requires that sound sources are present in an enclosed space. For example, this embodiment can produce a sound field in which audio is separated by the boundary plane of the enclosed space so that audio output from the speakers SP is not released to the outside of the enclosed space by performing filtering in accordance with coefficients ω adjusted so that the sound pressures and the sound pressure gradients at multiple control points CP set on the boundary plane of an enclosed space become zero. This allows a region outside the enclosed space to be made quiet.

### Third Embodiment

In the first and second embodiments, the multiple speakers SP are installed in the notebook computer 100 or another electronic device. In this case, the multiple speakers SP may be disposed at a non-movable portion of the electronic device. For example, if the electronic device is the notebook computer 100, the multiple speakers SP may be disposed on a surface on which a keyboard is disposed. In particular, in the first embodiment in which the filtering unit 10 is constituted by an FIR filter in which the coefficients ω are set as fixed values, the speakers SP may be disposed in a non-movable portion of the notebook computer 100 where the positions of the speakers SP are fixed.

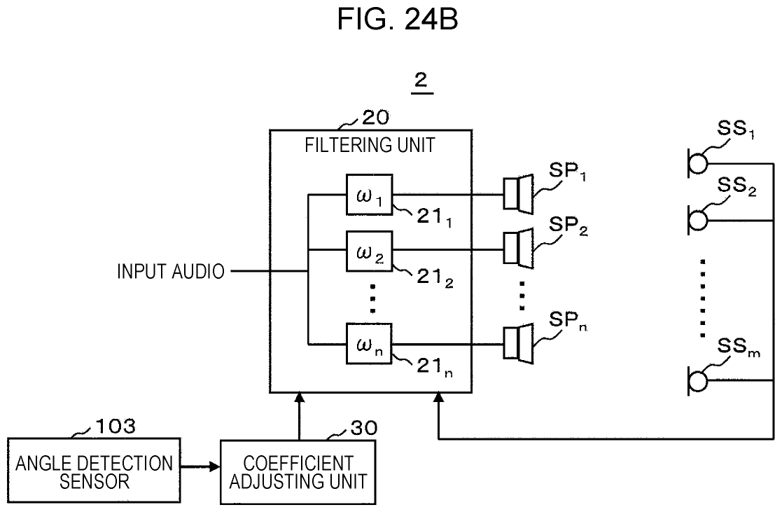

In contrast, as in a third embodiment described below, the multiple speakers SP may be disposed not only at the non-movable portion but also at multiple portions of the electronic device including a movable portion. FIG. 23 is a diagram simply illustrating an example in which the multiple speakers SP are disposed at the non-movable portion and the movable portion of the notebook computer 100. FIG. 23 illustrates an example in which a speaker SP101 is mounted on a keyboard surface 101, which is a non-movable portion of the notebook computer 100, and a speaker SP102 is mounted on a display surface 102, which is a movable portion of the notebook computer 100.

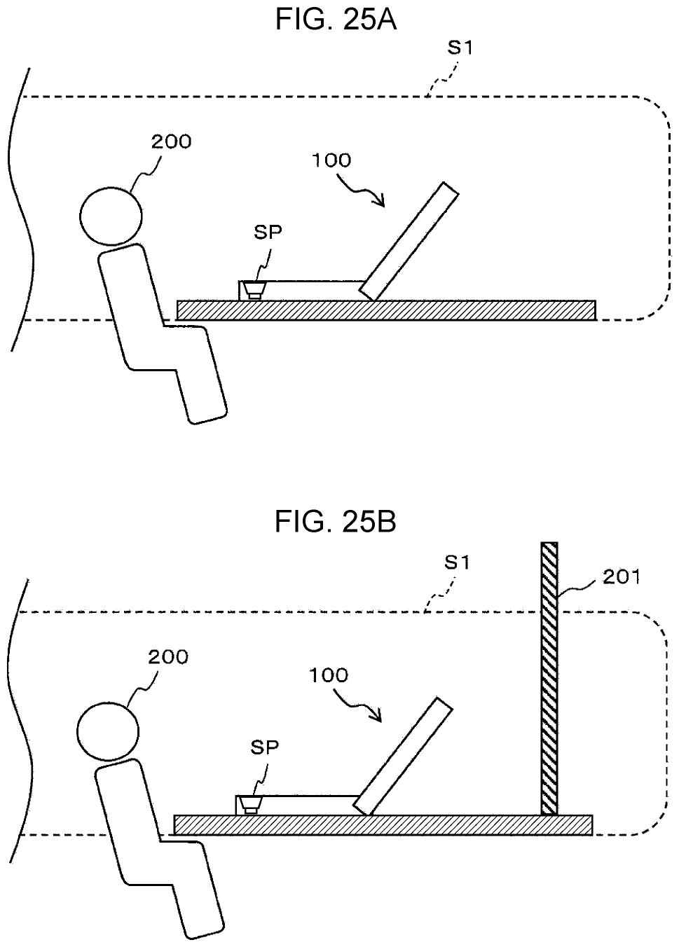

The speaker SP102 mounted on the display surface 102 changes in position in the enclosed spaces S1 and S2 according to the angle of the display surface 102 opened. For this reason, as illustrated in FIG. 23 and FIGS. 24A and 24B, an angle detection sensor 103 and a coefficient adjusting unit 30 for adjusting the coefficients ω set for the filtering unit 10 or 20 according to the angle detected by the angle detection sensor 103 may be provided. FIG. 24A illustrates a modification of the first embodiment illustrated in FIG. 3. FIG. 24B illustrates a modification of the second embodiment illustrated in FIG. 20.

The angle detection sensor 103 detects the angle of the display surface 102, which is a movable portion, with respect to the keyboard surface 101, which is a non-movable portion. The coefficient adjusting unit 30 stores, for example, function or table information for obtaining an adjustment coefficient based on the angle detected by the angle detection sensor 103, and adjusts the coefficients ω by performing multiplication with the adjustment coefficient. The function or table information can be designed based on the values of the coefficients ω adjusted at a plurality of angles in advance.

The coefficient adjusting unit 30 may store in advance, as table information, the adjusted coefficients ω (coefficients obtained by performing multiplication with the adjustment coefficient) for individual predetermined angles of the display surface 102, may obtain the adjusted coefficients ω corresponding to an angle closest to the angle detected by the angle detection sensor 103 from the table information, and may set the adjusted coefficients ω for the filtering unit 10 or 20.

### Fourth Embodiment

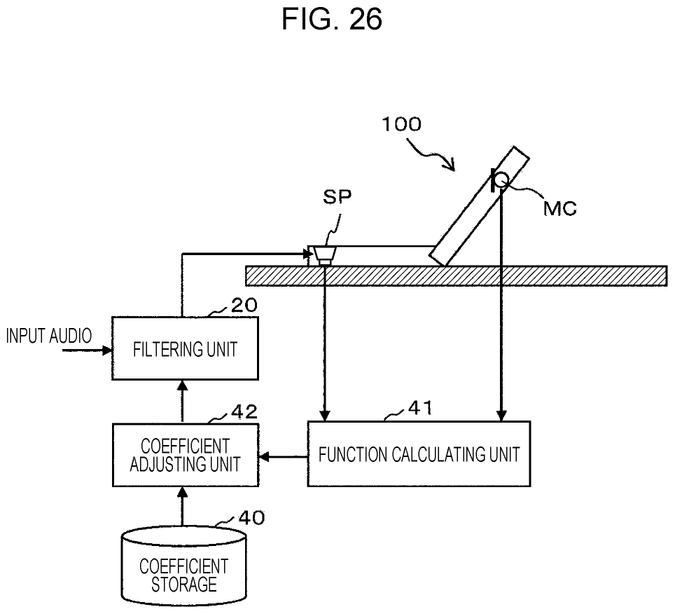

In the first to third embodiments, the coefficients ω adjusted so that the sound pressures and the sound pressure gradients at the multiple control points CP1 and CP2 set on the boundary planes of the enclosed spaces S1 and S2 reach values corresponding to a desired sound field are set for the filtering unit 10 or 20, with the notebook computer 100 and its user 200 present in the first enclosed space S1, as shown in FIG. 25A. In contrast, if a reflective object 201 that reflects sound is added into the first enclosed space S1 or the second enclosed space S2, in addition to the notebook computer 100 and the user 200, as illustrated in FIG. 25B, the performance of the sound field control can be decreased.

In contrast, the fourth embodiment prepares information for setting, for the filtering unit 10 or 20, coefficients ω necessary for controlling the interior of the enclosed space S1 or S2 to a desired sound field even when the reflective object 201 is added into the enclosed space S1 or S2, and adjusts the coefficients ω for the filtering unit 10 or 20 according to the added reflective object 201 using this information.

How the sound output from the speakers SP reflects in the enclosed space S1 or S2 changes depending on the position, size, and type of the reflective object 201 added into the enclosed space S1 or S2. In the fourth embodiment, the filtering unit 10 or 20 performs filtering in accordance with the coefficients ω set for any one of multiple different reflection patterns according to at least one of the position, size, and type of the reflective object 201 present in the enclosed space S1 or S2.

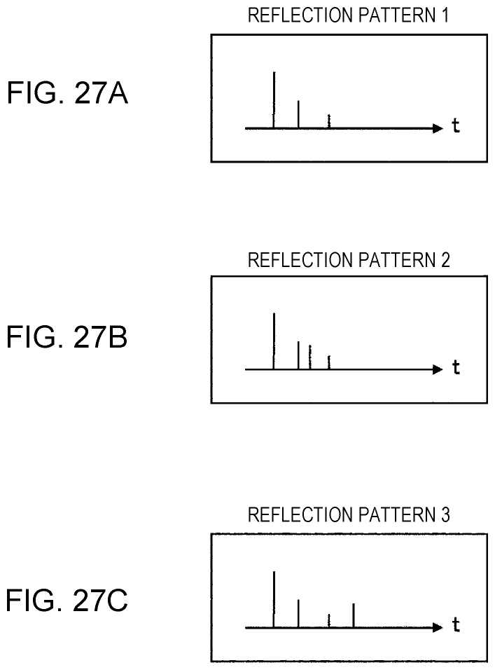

FIG. 26 is a diagram illustrating an example configuration of a sound field control apparatus according to the fourth embodiment. As illustrated in FIG. 26, the notebook computer 100 of the sound field control apparatus according to the fourth embodiment includes a microphone MC in addition to the speaker SP. The sound field control apparatus according to the fourth embodiment further includes a coefficient storage 40, a function calculating unit 41, and a coefficient adjusting unit 42 in addition to the filtering unit 20 (or the filtering unit 10).

The coefficient storage 40 stores in advance, for each reflection pattern, coefficients ω that are adjusted so that the sound pressures and the sound pressure gradients at multiple control points reach values corresponding to a desired sound field in the case where only the notebook computer 100 and the user 200 are present in the enclosed space S1 or S2 and in the case where the reflective object 201 is additionally present. In the case where the additional reflective object 201 is present, the coefficient storage 40 stores in advance multiple sets of coefficients ω for individual different reflection patterns according to at least one of the position, size, and type of the reflective object 201. The coefficients ω for each reflection pattern are adjusted in advance by actually setting the reflective objects 100, 200, and 201 in the enclosed space S1 or S2. The coefficient storage 40 stores the multiple sets of coefficients ω for different reflection patterns in association with identification information set for the individual reflection patterns.

The function calculating unit 41 calculates a predetermined function (in this specification, hereinafter referred to as a response function) indicating the transfer characteristics of the audio output from the speaker SP and input to the microphone MC disposed at a predetermined position. Examples of the response function include a cross-correlation function and an impulse response. These are mere examples and are not limited to the above. Any function representing how the audio output from the speaker SP is transmitted to the microphone MC can be used.

The position of the microphone MC relative to speaker SP may be nearly constant at any time the user 200 listens to the audio from the speaker SP. In the example of FIG. 26, the speaker SP is disposed at a non-movable portion of the notebook computer 100, and the microphone MC is disposed at a movable portion of the notebook computer 100, the relative positional relationship between the speaker SP. For this reason, the relative positional relationship between the speaker SP and the microphone MC is not always perfectly constant every time the user 200 uses the notebook computer 100 but may be nearly constant.

Both the speaker SP and the microphone MC may be disposed at a non-movable portion of the notebook computer 100. If the speaker SP is mounted at an electronic device without a movable portion (for example, a desktop PC), the relative positional relationship between the speaker SP and the microphone MC can be fixed by disposing the microphone MC at a predetermined position of the electronic device. If an electronic device without a movable portion is used at a fixed position on a desk, the microphone MC can be disposed at a fixed position separate from the electronic device.

The coefficient adjusting unit 42 sets, for the filtering unit 20, a coefficient ω selected from the multiple sets of coefficients ω stored in the coefficient storage 40 for individual reflection patterns according to the reflective object present in the enclosed space S1 or S2. Specifically, the coefficient adjusting unit 42 selects a coefficient ω stored in association with the identification information corresponding to the response function calculated by the function calculating unit 41 from the multiple coefficients ω stored for the individual reflection patterns in the coefficient storage 40 and sets the coefficient ω for the filtering unit 20.

The identification information may be the response function itself or characteristics information calculated from the response function using a predetermined algorithm. If the characteristics information is used as the identification information, the function calculating unit 41 calculates the response function and further calculates the characteristics information from the response function. The coefficient adjusting unit 42 reads a coefficient ω stored in association with the characteristics information calculated by the function calculating unit 41 from the coefficient storage 40 and sets the coefficient ω for the filtering unit 20.

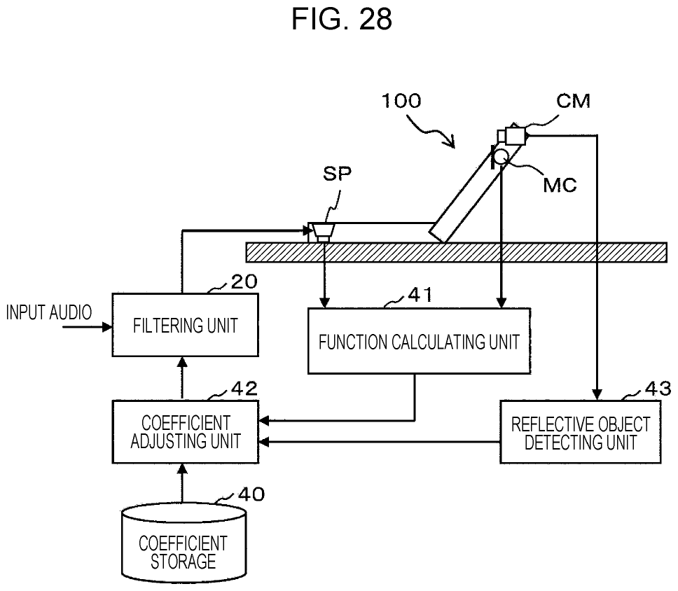

FIGS. 27A to 27C are schematic diagrams illustrating examples of the impulse response calculated by the function calculating unit 41. As illustrated in FIGS. 27A to 27C, the impulse response calculated by the function calculating unit 41 differs between when only the user 200 and the notebook computer 100 are present in the enclosed space S1 or S2 (for example, FIG. 27A) and when the reflective object 201 is additionally present (for example, FIGS. 27B and 27C). The impulse response differs depending on the position, size, and type of the additional reflective object 201. In other words, the impulse response varies from one reflection pattern to another. This allows the coefficient adjusting unit 42 to read a coefficient ω corresponding to the reflection pattern of the enclosed space S1 or S2 from the coefficient storage 40 based on the impulse response calculated by the function calculating unit 41 or characteristics information calculated from the impulse response and to set the coefficient ω for the filtering unit 20.

The filtering unit 20 performs filtering in accordance with the coefficient ω of the reflection pattern set by the coefficient adjusting unit 42 in correspondence with the response function calculated by the function calculating unit 41.

Even if the position, size, and type of the additional reflective object 201 present in the enclosed space S1 or S2 differs, the response function or the characteristics information calculated by the function calculating unit 41 can be similar. In this case, the coefficient adjusting unit 42 may read a coefficient ω corresponding to a reflection pattern different from the actual reflection pattern from the coefficient storage 40.

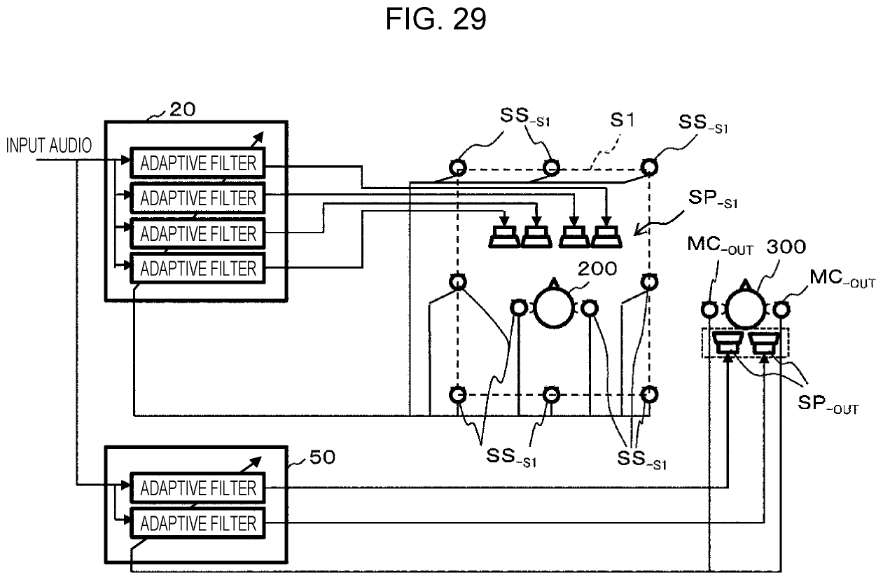

For this reason, as illustrated in FIG. 28, a reflective object detecting unit 43 may be provided that detects the additional reflective object 201 present in the enclosed space S1 or S2 based on an image of the interior of the enclosed space S1 or S2 captured by a camera CM disposed at a predetermined position, and filtering may be performed in accordance with the coefficient w of the reflection pattern set based on the response function calculated by the function calculating unit 41 and the detection state of the reflective object 201 detected by the reflective object detecting unit 43.

In the example of FIG. 28, the camera CM is disposed in the vicinity of the upper end of the movable portion of the notebook computer 100 and captures an image in front of the notebook computer 100 (in the direction of the user 200). For this reason, if the additional reflective object 201 is present in front of the notebook computer 100, the reflective object detecting unit 43 can detect the additional reflective object 201 from the captured image. In contrast, if the additional reflective object 201 is not present in front of the notebook computer 100 or if the additional reflective object 201 is present at the back of the notebook computer 100, the reflective object 201 is not detected from the captured image.

In the example, of FIG. 28, the coefficient storage 40 stores a coefficient ω to be set for the filtering unit 20 when the additional reflective object 201 is present in front of the notebook computer 100 and a coefficient w to be set for the filtering unit 20 when the additional reflective object 201 is present at the back of the notebook computer 100 in a distinguishable manner. This allows, even if multiple pieces of identification information similar to the response function calculated by the function calculating unit 41 or the characteristics information are stored in the coefficient storage 40, selecting a suitable coefficient ω depending on whether the additional reflective object 201 is detected by the reflective object detecting unit 43 (whether the additional reflective object 201 is present in front of or at the back of the notebook computer 100).

The coefficients ω for the individual reflection patterns may be stored in the coefficient storage 40 so that at what position in front of the notebook computer 100, what size, and what type of additional reflective object 201 is present can be determined. This allows more accurate selection of the coefficient w depending on the detection state of the additional reflective object 201 detected by the reflective object detecting unit 43.

The installation position of the camera CM is not limited to the example in FIG. 28. The camera CM may be installed at a position different from the notebook computer 100. Multiple cameras CM may be mounted so as to capture not only an image in front of the notebook computer 100 but images in other directions.

In the fourth embodiment, multiple coefficients ω are stored for individual reflection patterns in advance in the coefficient storage 40, and the coefficient adjusting unit 42 reads one of the coefficients w from the coefficient storage 40 and sets the coefficient ω for the filtering unit 10 or 20. This is, however, illustrative only. For example, adjustment coefficients for adjusting the coefficient ω so that, when the additional reflective object 201 is present in the enclosed space S1 or S2, the sound pressures and the sound pressure gradients at multiple control points reach values corresponding to a desired sound field may be stored in advance in the coefficient storage 40 for the individual multiple reflection patterns. In this case, the coefficient adjusting unit 42 sets the coefficient ω by reading an adjustment coefficient for the corresponding reflection pattern from the coefficient storage 40 based on the response function calculated by the function calculating unit 41 or the characteristics information and multiplying a default coefficient w for the case where the additional reflective object 201 is not present by the adjustment coefficient.

In another example, instead of the coefficient adjusting unit 42 reading the coefficient ω for the corresponding reflection pattern or the adjustment coefficient from the coefficient storage 40 based on the response function calculated by the function calculating unit 41 or the characteristics information, the coefficient adjusting unit 42 may read the coefficient ω for the corresponding reflection pattern or the adjustment coefficient from the coefficient storage 40 based on an instruction from the user 200. For example, at least one of the position, size, and type of the additional reflective object 201 that is visually recognized by the user 200 may be specified with a predetermined user interface, and a coefficient ω or an adjustment coefficient corresponding to the specified item may be read from the coefficient storage 40. In this case, the function calculating unit 41 and the reflective object detecting unit 43 may be omitted.

### Fifth Embodiment

In the first to fourth embodiments, a sound field in which audio is separated by the boundary plane of the first enclosed space S1 to prevent the audio output from the speakers SP from releasing to the outside of the first enclosed space S1 is produced by performing filtering on the input audio signals in accordance with coefficients ω adjusted so that sound pressures and sound pressure gradients at the multiple control points CP1 set at least on the boundary plane of the first enclosed space S1 become zero. However, it is difficult to completely bring the sound pressure outside the first enclosed space S1 to zero.

In contrast, the fifth embodiment is configured to, when a second person is present near the first enclosed space S1 in the region outside the first enclosed space S1, prevent audio leaking from the first enclosed space S1 from being heard by the second person as much as possible. In the fifth embodiment, a speaker and a microphone are disposed at a headrest at the position where the second person is seated, and the audio leaking from the first enclosed space S1 to reach the ears of the second person is cancelled (offset) by the audio output from the speakers of the headrest.

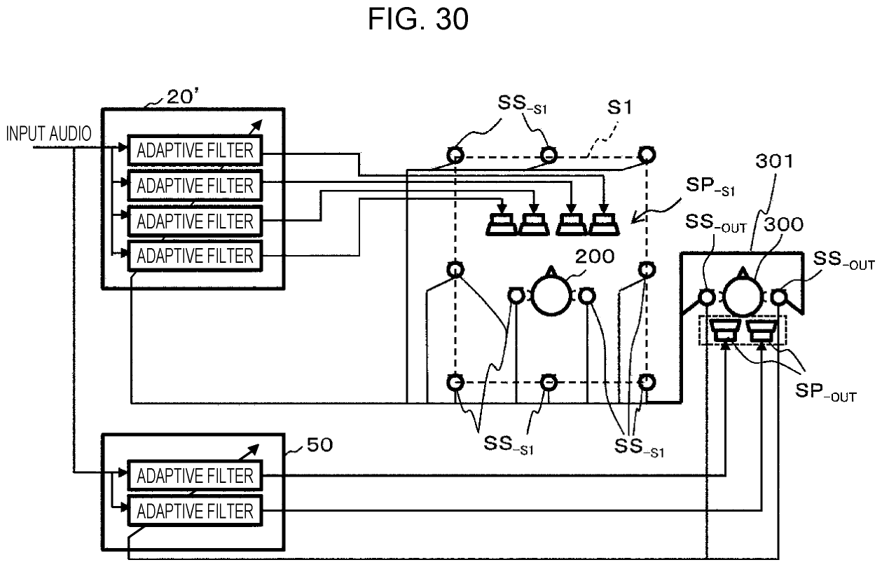

FIG. 29 is a diagram illustrating an example configuration of a sound field control apparatus according to the fifth embodiment. In FIG. 29, the components having the same functions as the components illustrated in the second embodiment are given the same reference signs. In FIG. 29, multiple speakers SP-S1 (hereinafter referred to as inner speakers SP-S1) installed in the first enclosed space S1 are the same as the multiple speakers SP illustrated in FIG. 20. Multiple sound pressure/sound pressure gradient sensors SS-S1 installed on and inside the boundary plane of the first enclosed space S1 are the same as the multiple sound pressure/sound pressure gradient sensors SS illustrated in FIG. 20.

In the example illustrated in FIG. 29, the filtering unit 20 performs filtering in accordance with the coefficients ω set for multiple audio outputs from the multiple internal speakers SP-S1 and corresponds to an enclosed-space filtering unit in the accompanying claims. In other words, the filtering unit 20 performs filtering on the input audio signals in accordance with the coefficients ω adjusted so that the sound pressures and the sound pressure gradients at multiple control points set on and inside the boundary plane of the first enclosed space S1 (where the sound pressure/sound pressure gradient sensors SS-S1 are disposed) reach values corresponding to a desired sound field.

In the example shown in FIG. 29, a second user 300 is present outside the first enclosed space S1 and near the first enclosed space S1, and a headrest is present at a fixed position where the second user 300 is seated. One speaker SP-OUT (hereinafter referred to as an external speaker SP-OUT) and one microphone MC-OUT are set on either side of the headrest. A filtering unit 50 constituted by adaptive filters for controlling audio output from the external speakers SP-OUT is provided.

The filtering unit 50 performs filtering on the input audio signals in accordance with the coefficients ω adjusted so that the sound pressures at control points set in the vicinity of the external speakers SP-OUT (the positions of the microphones MC-OUT on the headrest) reach a desired sound pressure. The desired sound pressure is a sound pressure that cancels the sound pressure of the audio input to the microphones MC-OUT. This allows the audio from the internal speakers SP-S1 leaking from the first enclosed space S1 to reach the vicinity of the positions of the microphones MC-OUT to be reduced in pressure by the audio output from the external speakers SP-OUT. This can further make the position of the second user 300 quiet.

Although FIG. 29 illustrates an example in which the filtering unit 20 similar to that of the second embodiment is used as the enclosed-space filtering unit, the filtering unit 10 similar to that of the first embodiment may be used. In this case, after the coefficients ω are set for the filtering unit 10, installation of the sound pressure/sound pressure gradient sensors SS-S1 on and inside the boundary plane of the first enclosed space S1 may be omitted. The fifth embodiment may also adopt the configuration illustrated in the third embodiment. Although FIG. 29 illustrates an example in which control points are set also in the first enclosed space S1 as in the tenth design example, these may be omitted. Although FIG. 29 illustrates an example in which two external speakers SP-OUT and two microphones MC-OUT are mounted at either side of the headrest, only one external speaker SP-OUT and one microphone MC-OUT may be mounted. This modification is also applicable to first to third modifications described below.

### First Modification of Fifth Embodiment

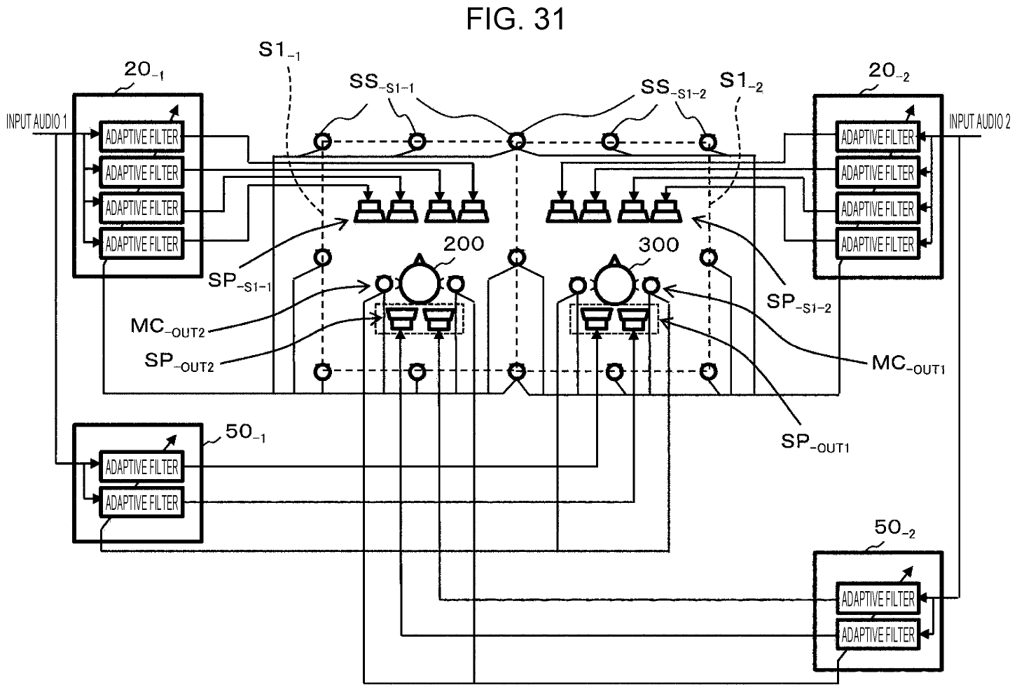

FIG. 30 is a diagram illustrating an example configuration of a sound field control apparatus according to a first modification of the fifth embodiment. In FIG. 30, the components having the same functions as the components illustrated in FIG. 29 are given the same reference signs. In the first modification, sound pressure/sound pressure gradient sensors SS-OUT are disposed on either side of the headrest, in place of the microphones MC-OUT illustrated in FIG. 29. In place of the filtering unit 20 illustrated in FIG. 29, a filtering unit 20′ is provided.

In the first modification, a filtering unit 50 performs filtering on the input audio signals in accordance with the coefficients ω adjusted so that the sound pressures at control points set in the vicinity of the external speakers SP-OUT (the positions of the sound pressure/sound pressure gradient sensors SS-OUT on the headrest) reach a desired sound pressure. This is the same as in the fifth embodiment.

In contrast, the filtering unit 20′, which is connected to a wiring line 301 indicated by the heavy line added to FIG. 29, performs filtering on the input audio signals in accordance with coefficients ω adjusted so that the sound pressures and the sound pressure gradients at multiple control points set on and inside the boundary plane of the first enclosed space S1 (the positions where the sound pressure/sound pressure gradient sensors SS-S1 are disposed) and at the control points set in the vicinity of the external speakers SP-OUT (the positions where the sound pressure/sound pressure gradient sensors SS-OUT are disposed) reach values corresponding to a desired sound field. In other words, the filtering unit 20′ receives audio from the sound pressure/sound pressure gradient sensors SS-S1 disposed in the first enclosed space S1 and also the sound pressure/sound pressure gradient sensors SS-OUT disposed at the headrest outside the first enclosed space S1 and adaptively adjusts the coefficients ω based on the input audio.

This configuration allows the sound pressure of audio leaking from the first enclosed space S1 toward the external sound pressure/sound pressure gradient sensors SS-OUT (that is, toward the second user 300) to be lower than that in the fifth embodiment illustrated in FIG. 29. Since the thus weakened audio is reduced in pressure by the audio controlled by the filtering unit 50 and output from the external speakers SP-OUT, the audio at the position of the second user 300 to be made even quieter.

### Second Modification of Fifth Embodiment

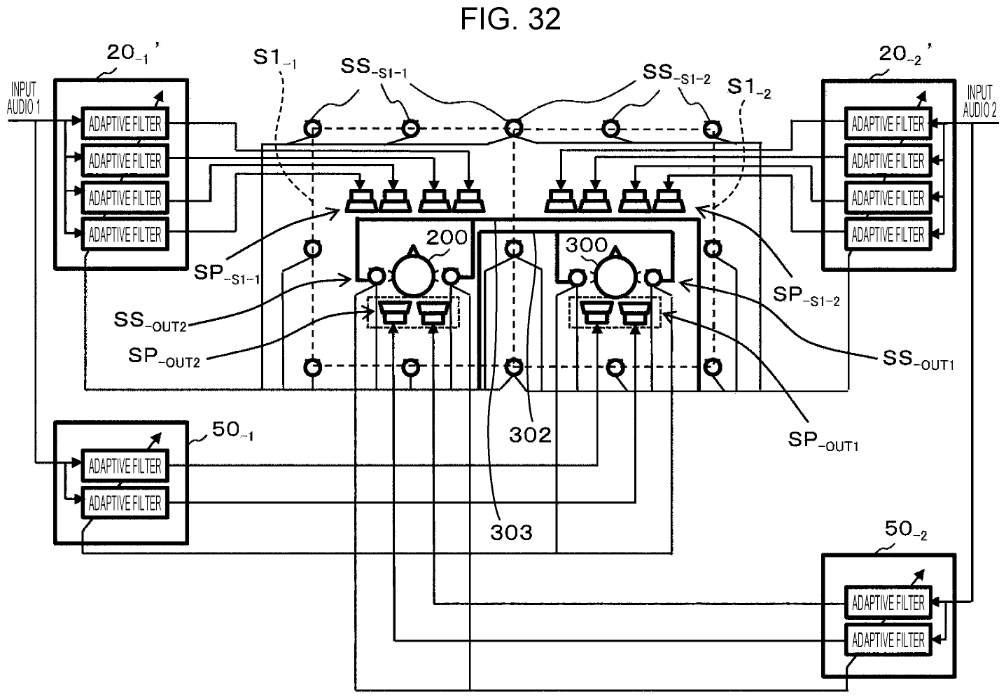

FIG. 31 is a diagram illustrating an example configuration of a sound field control apparatus according to a second modification of the fifth embodiment.

In the second modification, the second user 300, who is next to the user 200, is listening to second audio different from first audio that the user 200 is listening to, and the fifth embodiment illustrated in FIG. 29 is applied to both the user 200 and the second user 300.

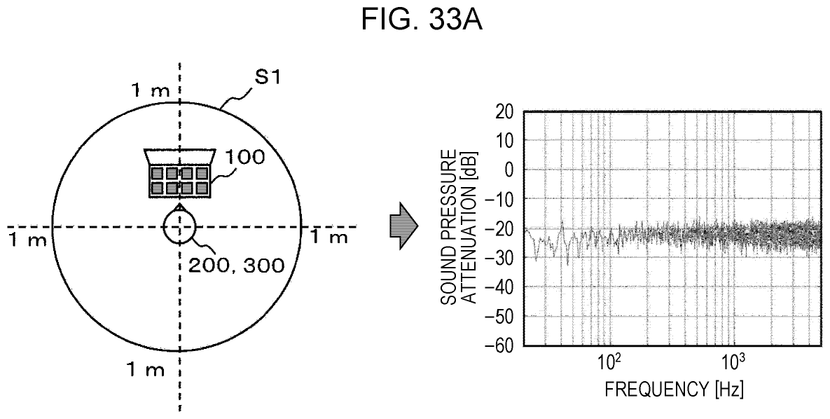

In other words, in the second modification, the first enclosed space S1 includes a first space S1-1 surrounding the internal speakers SP-S1-1 that output audio that the first user 200 is listening to and a second space S1-2 surrounding the internal speakers SP-S1-2 that output audio that the second user 300 is listening to. The first space S1-1 and the second space S1-2 are next to each other along one boundary plane. The control points set on the boundary plane shared by the first space S1-1 and the second space S1-2a are shared by the first space S1-1 and the second space S1-2. For this reason, the sound pressure/sound pressure gradient sensors SS (three in the example of FIG. 32) disposed on the boundary plane shared by the first space S1-1 and the second space S1-2 are shared by the first space S1-1 and the second space S1-2.

In the second modification, external speakers SP-OUT1 and microphones MC-OUT1 for the first space S1-1 are present in the second space S1-2, and external speakers SP-OUT2 and microphones MC-OUT2 for the second space S1-2 are present in the first space S1-1. A filtering unit 20-1 serving as a first enclosed-space filtering unit and a filtering unit 50-1 serving as a first outside-of-closed-space filtering unit are provided for the first space S1-1, and a filtering unit 202 serving as a second enclosed-space filtering unit and a filtering unit 50-2 serving as a second outside of-closed-space filtering unit are provided for the second space S1-2.

The processes of the filtering units 20-1 and 20-2 serving as enclosed-space filtering units are the same as the process of the filtering unit 20 described with reference to FIG. 29. The processes of the filtering unit 50-1 and 50-2 serving as outside of-closed-space filtering units are the same as the process of the filtering unit 50 described with reference to FIG. 29.

In other words, the filtering unit 20-1 performs filtering on the input first audio signals in accordance with the coefficients ω adjusted so that the sound pressures and the sound pressure gradients at multiple control points set on and inside the boundary plane of the first space S1-1 (the positions where the sound pressure/sound pressure gradient sensors SS-S1-1 are mounted) reach values corresponding to a desired sound field. The filtering unit 50-1 performs filtering on the input first audio signals in accordance with the coefficients ω adjusted so that the sound pressures at control points set in the vicinity of the external speakers SP-OUT1 in the second space S1-2 (the positions at which the microphones MC-OUT1 are mounted) reach a desired sound pressure.

The filtering unit 20-2 performs filtering on the input second audio signals in accordance with the coefficients ω adjusted so that the sound pressures and the sound pressure gradients at multiple control points set on and inside the boundary plane of the second space S1-2 (the positions at which the sound pressure/sound pressure gradient sensors SS-S1-2 are mounted) reach values corresponding to a desired sound field. The filtering unit 50-2 performs filtering on the input second audio signals in accordance with coefficients ω adjusted so that the sound pressures at control points set in the vicinity of the external speakers SP-OUT2 in the first space S1-1 (the positions at which the microphones MC-OUT2 are mounted) reach a desired sound pressure.

### Third Modification of Fifth Embodiment

FIG. 32 is a diagram illustrating an example configuration of a sound field control apparatus according to a third modification of the fifth embodiment. In FIG. 32, the components having the same functions as the components illustrated in FIG. 31 are given the same reference signs. In the third modification, sound pressure/sound pressure gradient sensors SS-OUT1 and SS-OUT2 are disposed on either side of the headrest, instead of the microphones MC-OUT1 and MC-OUT2 illustrated in FIG. 31. In place of the filtering units 20-1 and 20-2 illustrated in FIG. 31, filtering units 20-1′ and 20-2′ are provided.

In the third modification, the filtering units 50-1 and 50-2 performs filtering on the input audio signals in accordance with coefficients ω adjusted so that the sound pressures at control points set in the vicinity of the external speakers SP-OUT1 and SP-OUT2 (the positions at which the sound pressure/sound pressure gradient sensors SS-OUT1 and SP-OUT2 are mounted) reach a desired sound pressure. This is the same as in the second modification.

In contrast, the filtering unit 20-1′, which is connected to a wiring line 302 indicated by the heavy line added to FIG. 31, performs filtering on the input first audio signals in accordance with coefficients ω adjusted so that the sound pressures and the sound pressure gradients at multiple control points set on and inside the boundary plane of the first space S1-1 (the positions where the sound pressure/sound pressure gradient sensors SS-S1-1 are disposed) and at the control points set in the vicinity of the external speakers SP-OUT1 (the positions where the sound pressure/sound pressure gradient sensors SS-OUT1 are disposed) reach values corresponding to a desired sound field. In other words, the filtering unit 20-1′ receives audio from the sound pressure/sound pressure gradient sensors SS-S1-1 disposed in the first space S1-1 and also the sound pressure/sound pressure gradient sensors SS-OUT1 disposed in the second space S1-2 outside the first space S1-1 and adaptively adjusts the coefficients w based on the input audio.

Likewise, the filtering unit 20-2′, which is connected to a wiring line 303 indicated by the heavy line added to FIG. 31, performs filtering on the input second audio signals in accordance with coefficients ω adjusted so that the sound pressures and the sound pressure gradients at multiple control points set on and inside the boundary plane of the second space S1-2 (the positions where the sound pressure/sound pressure gradient sensors SS-S1-2 are disposed) and at the control points set in the vicinity of the external speakers SP-OUT2 (the positions where the sound pressure/sound pressure gradient sensors SS-OUT2 are disposed) reach values corresponding to a desired sound field. In other words, the filtering unit 20-2′ receives audio from the sound pressure/sound pressure gradient sensors SS-S1-2 disposed in the second space S1-2 and also the sound pressure/sound pressure gradient sensors SS-OUT2 disposed in the first space S1-1 outside the second space S1-2 and adaptively adjusts the coefficients ω based on the input audio.

In other words, the filtering unit 20-1′ performs filtering on the input first audio signals in accordance with the coefficients ω adjusted so that the sound pressures and the sound pressure gradients at multiple control points set on and inside the boundary plane of the first space S1-1 (the positions where the sound pressure/sound pressure gradient sensors SS-S1-1 are mounted) and at the control points set in the vicinity of the external speakers SP-OUT1 present in the second space S1-2 (the positions where the sound pressure/sound pressure gradient sensors SS-OUT1 are disposed) reach values corresponding to a desired sound field. The filtering unit 50-1 performs filtering on the input first audio signals in accordance with the coefficients ω adjusted so that the sound pressures at control points set in the vicinity of the external speakers SP-OUT1 in the second space S1-2 (the positions at which the sound pressure/sound pressure gradient sensors SS-OUT1 are mounted) reach a desired sound pressure.

The filtering unit 20-2′ performs filtering on the input second audio signals in accordance with the coefficients ω adjusted so that the sound pressures and the sound pressure gradients at multiple control points set on and inside the boundary plane of the second space S1-2 (the positions where the sound pressure/sound pressure gradient sensors SS-S1-2 are mounted) and at the control points set in the vicinity of the external speakers SP-OUT2 present in the first space S1-1 (the positions where the sound pressure/sound pressure gradient sensors SS-OUT2 are disposed) reach values corresponding to a desired sound field. The filtering unit 50-2 performs filtering on the input second audio signals in accordance with the coefficients ω adjusted so that the sound pressures at control points set in the vicinity of the external speakers SP-OUT2 in the first space S1-1 (the positions at which the sound pressure/sound pressure gradient sensors SS-OUT2 are mounted) reach a desired sound pressure.

This configuration allows the sound pressure of audio output from the speakers SP-S1-1 in the first space S1-1 leaking toward the external sound pressure/sound pressure gradient sensors SS-OUT1 (that is, toward the second user 300) to be lower than that of the second modification illustrated in FIG. 31. The thus weakened audio is reduced in pressure by the audio controlled by the filtering unit 50-1 and output from the external speakers SP-OUT1. This can make the audio output from the external speakers SP-OUT1 hardly heard by the second user 300.

Likewise, the sound pressure of audio output from the speakers SP-S1-2 in the second space S1-2 leaking toward the external sound pressure/sound pressure gradient sensors SS-OUT2 (that is, toward the first user 200) to be lower than that of the second modification illustrated in FIG. 31. The thus weakened audio is reduced in pressure by the audio controlled by the filtering unit 50-2 and output from the external speakers SP-OUT2. This can make the audio output from the external speakers SP-OUT2 hardly heard by the first user 200.

Although the second and third modifications illustrate examples in which the first space S1-1 and the second space S1-2 are next to each other along one boundary plane, the first space S1-1 and the second space S1-2 only need to be close to each other, and it does not mean that the second and third modifications are applicable only when they are next to each other.

Although the fifth embodiment illustrates an example in which only the first enclosed space S1 is present, the embodiment is applicable to a case where the first enclosed space S1 and the second enclosed space S2 are present. If the second enclosed space S2 is present, in the second and third modifications, the second enclosed space S2 also includes a first space S2-1 and a second space S2-2, and the first enclosed space S1 includes the first space S1-1 and the second space S1-2. The first space S2-1 and the second space S2-2 of the second enclosed space S2 are disposed close to each other.

In the first to fifth embodiments, the filtering units 10, 20, and 20′ achieve audio separation by performing filtering on input audio signals in accordance with coefficients ω adjusted so that the sound pressures and the sound pressure gradients at the multiple control points CP1 and CP2 set on the boundary planes of the enclosed spaces S1 and S2. The present disclosure is not limited to the above embodiments. For example, the filtering units 10, 20, and 20′ may perform filtering on the input audio signals in accordance with coefficients ω adjusted so that the sound pressures and the sound pressure gradients at the multiple control points CP1 set on the boundary plane of the first enclosed space S1 reach values corresponding to a desired sound field, and that the sound pressures and the sound pressure gradients at the multiple control points CP2 set on the boundary plane of the second enclosed space S2 reach values corresponding to the desired sound field.

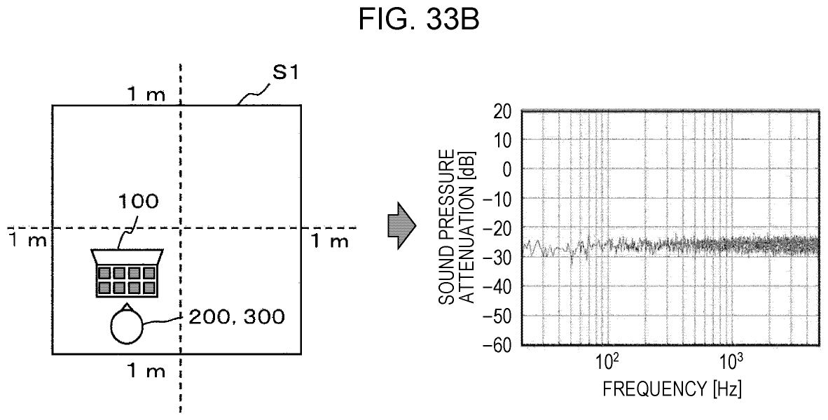

Although the first to fifth embodiments illustrate examples in which the enclosed spaces S1 and S2 are rectangular spaces centered on the positions of the users 200 and 300, respectively, the present disclosure is not limited to the embodiments. In other words, the control points CP1 and CP2 may be set so as to surround the multiple speakers SP. For example, the enclosed spaces S1 and S2 may be circular as illustrated in FIG. 33A. The users 200 and 300 may be eccentric from the centers of the enclosed spaces S1 and S2, respectively, as illustrated in FIG. 33B.

It is to be understood that the embodiments and the design examples are illustrative only in implementing the present disclosure and should not be construed as limiting the technical scope of the present disclosure. In other words, various changes and modifications of the present disclosure may be made without departing from the spirit and scope thereof.

1. A sound field control apparatus for producing a sound field by controlling sound pressures and sound pressure gradients at predetermined control points, the apparatus comprising:
a filtering unit configured to perform filtering on input audio signals in accordance with coefficients set for a plurality of audio outputs, respectively; and
a plurality of speakers configured to output audio in response to audio signals filtered for the plurality of audio outputs by the filtering unit,
wherein the filtering unit is configured to perform the filtering on the input audio signals in accordance with the coefficients adjusted so that sound pressures and sound pressure gradients at a plurality of control points set on a boundary plane of an enclosed space surrounding the plurality of speakers reach values corresponding to a desired sound field.

2. The sound field control apparatus according to claim 1, wherein:
the enclosed space comprises a first enclosed space surrounding the plurality of speakers and a second enclosed space surrounding the first enclosed space, and
the filtering unit is configured to perform the filtering on the input audio signals in accordance with the coefficients adjusted so that sound pressures and sound pressure gradients at a plurality of control points set on a boundary plane of the first enclosed space reach values corresponding to the desired sound field and that sound pressures and sound pressure gradients at a plurality of control points set on a boundary plane of the second enclosed space reach values corresponding to the desired sound field.

3. The sound field control apparatus according to claim 2, wherein the filtering unit is configured to perform the filtering on the input audio signals in accordance with the coefficients adjusted so that both the sound pressures and the sound pressure gradients at the plurality of control points set on the boundary plane of the first enclosed space become zero and that both the sound pressures and the sound pressure gradients at the plurality of control points set on the boundary plane of the second enclosed space become zero.

4. The sound field control apparatus according to claim 1, wherein:
the enclosed space comprises one enclosed space surrounding the plurality of speakers, and
the filtering unit is configured to perform the filtering on the input audio signals in accordance with the coefficients adjusted so that both the sound pressures and the sound pressure gradients at the plurality of control points set on the boundary plane of the enclosed space become zero.

5. The sound field control apparatus according to claim 4, wherein the filtering unit is configured to perform the filtering on the input audio signals in accordance with the coefficients adjusted so that the sound pressures and the sound pressure gradients at the plurality of control points set on the boundary plane of the enclosed space reach values corresponding to the desired sound field and that a sound pressure at one or more control points set in the enclosed space reaches a desired sound pressure.

6. The sound field control apparatus according to claim 4, wherein the plurality of speakers is arranged in two or more rows.

7. The sound field control apparatus according to claim 4, wherein the plurality of speakers is arranged in a non-movable portion of an electronic device.

8. The sound field control apparatus according to claim 4, wherein:
the plurality of speakers is arranged at a plurality of locations including a movable portion of an electronic device, and
the sound field control apparatus further comprises:
an angle detection sensor configured to detect an angle of the movable portion with respect to a non-movable portion; and
a coefficient adjusting unit configured to adjust the coefficients set for the filtering unit depending on the angle detected by the angle detection sensor.

9. The sound field control apparatus according to claim 4, further comprising:
a plurality of sound pressure/sound pressure gradient sensors disposed at the plurality of control points,
wherein the filtering unit includes filters in which the coefficients adjusted using sound pressures and sound pressure gradients detected by the plurality of sound pressure/sound pressure gradient sensors are individually set as fixed values.

10. The sound field control apparatus according to claim 4, further comprising:
a plurality of sound pressure/sound pressure gradient sensors disposed at the plurality of control points,
wherein the filtering unit includes adaptive filters in which the coefficients are variably set using sound pressures and sound pressure gradients detected by the plurality of sound pressure/sound pressure gradient sensors.

11. The sound field control apparatus according to claim 1, wherein the filtering unit is configured to perform the filtering in accordance with a coefficient set for any of a plurality of different reflection patterns according to at least one of a position, a size, or a type of a reflective object present in the enclosed space.

12. The sound field control apparatus according to claim 11, further comprising:
a function calculating unit configured to calculate a predetermined function indicating a transfer characteristic of audio output from the speakers and input to a microphone disposed at a predetermined position,
wherein the filtering unit is configured to perform the filtering according to a coefficient for a reflection pattern set for the predetermined function calculated by the function calculating unit.

13. The sound field control apparatus according to claim 12, further comprising:
a reflective object detecting unit configured to detect the reflective object present in the enclosed space based on an image of an interior of the enclosed space captured by a camera disposed at a predetermined position,
wherein the filtering unit is configured to perform the filtering in accordance with the coefficient for the reflection pattern set based on the predetermined function calculated by the function calculating unit and a state of the reflective object detected by the reflective object detecting unit.

14. The sound field control apparatus according to claim 1, further comprising:
one or more external speakers present outside the enclosed space in addition to a plurality of internal speakers present in the enclosed space, the internal speakers being the plurality of speakers,
wherein the filtering unit includes:
an enclosed-space filtering unit configured to perform filtering in accordance with coefficients individually set for the plurality of audio outputs for the plurality of internal speakers; and
an outside-of-enclosed-space filtering unit configured to perform filtering in accordance with a coefficient set for one or more audio outputs for the one or more external speakers.

15. The sound field control apparatus according to claim 14, wherein:
the enclosed-space filtering unit is configured to perform the filtering on the input audio signals in accordance with the coefficients adjusted so that the sound pressures and the sound pressure gradients at the plurality of control points set on the boundary plane of the enclosed space reach values corresponding to the desired sound field, and
the outside-of-enclosed-space filtering unit is configured to perform the filtering on the input audio signal in accordance with the coefficient adjusted so that a sound pressure at a control point set in the vicinity of the one or more external speakers reach a desired sound pressure.

16. The sound field control apparatus according to claim 14, wherein:
the enclosed-space filtering unit performs the filtering on the input audio signals in accordance with the coefficients adjusted so that the sound pressures and the sound pressure gradients at the plurality of control points set on the boundary plane of the enclosed space and at a control point set in the vicinity of the one or more external speakers reach values corresponding to the desired sound field, and
the outside-of-enclosed-space filtering unit is configured to perform the filtering on the input audio signal in accordance with the coefficient adjusted so that a sound pressure at a control point set in the vicinity of the one or more external speakers reach a desired sound pressure.

17. The sound field control apparatus according to claim 15, wherein:
the enclosed space includes a first space and a second space that are close to each other,
one or more external speakers for the first space are present in the second space, and one or more external speakers for the second space are present in the first space,
a first enclosed-space filtering unit and a first outside-of-enclosed-space filtering unit are provided for the first space, and a second enclosed-space filtering unit and a second outside-of-enclosed-space filtering unit are provided for the second space,
the first enclosed-space filtering unit performs the filtering on the input audio signals in accordance with the coefficients adjusted so that the sound pressures and the sound pressure gradients at the plurality of control points set on a boundary plane of the first space reach values corresponding to the desired sound field,
the first outside-of-enclosed-space filtering unit is configured to perform the filtering on the input audio signal in accordance with the coefficient adjusted so that the sound pressure at the control point set in the vicinity of the one or more external speakers present in the second space reaches a desired sound pressure,
the second enclosed-space filtering unit is configured to perform the filtering on the input audio signals in accordance with the coefficients adjusted so that the sound pressures and the sound pressure gradients at the plurality of control points set on a boundary plane of the second space reach values corresponding to the desired sound field, and
the second outside-of-enclosed-space filtering unit is configured to perform the filtering on the input audio signal in accordance with the coefficient adjusted so that the sound pressure at the control point set in the vicinity of the one or more external speakers present in the first space reaches a desired sound pressure.

18. The sound field control apparatus according to claim 16, wherein:
the enclosed space includes a first space and a second space that are close to each other,
one or more external speakers for the first space are present in the second space, and one or more external speakers for the second space are present in the first space,
a first enclosed-space filtering unit and a first outside-of-enclosed-space filtering unit are provided for the first space, and a second enclosed-space filtering unit and a second outside-of-enclosed-space filtering unit are provided for the second space,
the first enclosed-space filtering unit is configured to perform the filtering on the input audio signals in accordance with the coefficients adjusted so that the sound pressures and the sound pressure gradients at the plurality of control points set on a boundary plane of the first space and at a control point set in the vicinity of the one or more external speakers present in the second space reach values corresponding to the desired sound field,
the first outside-of-enclosed-space filtering unit is configured to perform the filtering on the input audio signal in accordance with the coefficient adjusted so that the sound pressure at the control point set in the vicinity of the one or more external speakers present in the second space reaches a desired sound pressure,
the second enclosed-space filtering unit is configured to perform the filtering on the input audio signals in accordance with the coefficients adjusted so that the sound pressures and the sound pressure gradients at the plurality of control points set on a boundary plane of the second space and at a control point set in the vicinity of the one or more external speakers present in the first space reach values corresponding to the desired sound field, and
the second outside-of-enclosed-space filtering unit is configured to perform the filtering on the input audio signal in accordance with the coefficient adjusted so that the sound pressure at the control point set in the vicinity of the one or more external speakers present in the first space reaches a desired sound pressure.

19. The sound field control apparatus according to claim 17, wherein a control point set on a boundary plane shared by the first space and the second space is shared by the first space and the second space.

20. A sound field control method for producing a sound field by controlling sound pressures and sound pressure gradients at predetermined control points in a system including a filtering unit configured to perform filtering on input audio signals in accordance with coefficients set for a plurality of audio outputs, respectively, and a plurality of speakers configured to output audio in response to audio signals filtered for the plurality of audio outputs by the filtering unit, the method comprising:
performing filtering on the input audio signals in accordance with the coefficients adjusted so that the sound pressures and the sound pressure gradients at a plurality of control points set on a boundary plane of an enclosed space surrounding the plurality of speakers reach values corresponding to a desired sound field.
